(19) United States
(12) Patent Application Publication
(10) Pub. No.: US 2026/0262904 A1
(43) Pub. Date: Sep. 10, 2026

(54) CLEANING ASSEMBLY, CLEANING DEVICE, AND CLEANING SYSTEM

(71) Applicant: Dreame Innovation Technology (Suzhou) Co., Ltd., Suzhou (CN)

(72) Inventors: Wei XIONG, Suzhou (CN); Xiuyuan HAN, Suzhou (CN); Zhusheng HUANG, Suzhou (CN)

(21) Appl. No.: 19/659,788

(22) Filed: Apr. 27, 2026

Related U.S. Application Data
(63) Continuation of application No. PCT/CN2025/134514, filed on Nov. 12, 2025.

(30) Foreign Application Priority Data
Nov. 15, 2024 (CN) 202422796731.3

(51) Int. Cl. A47L 13/256; F26B 3/18

(52) U.S. Cl. CPC A47L 13/256; F26B 3/18

(57) ABSTRACT

The present application provides a cleaning assembly, a cleaning device, and a cleaning system, the cleaning assembly includes: a mop cloth mounting bracket and a mop cloth; the mop cloth is mounted on the mop cloth mounting bracket; where the mop cloth mounting bracket and/or the mop cloth includes a phase-change material, the phase-change material is thermally conductively connected to the mop cloth, such that when the mop cloth is in a non-cleaning operation, the phase-change material absorbs heat from a heat source, and when the mop cloth performs a cleaning operation, the phase-change material releases the heat back to the mop cloth; and the non-cleaning operation includes at least part of a cleaning process, a drying process, or a soaking-and-heating process of the mop cloth. The present application may solve the technical problem of poor cleaning performance caused by existing cleaning devices using room temperature water for cleaning.

### CROSS-REFERENCE TO RELATED APPLICATION

This application is a continuation of International Application No. PCT/CN2025/134514, filed on Nov. 12, 2025, which claims priority to Chinese Patent Application No. 202422796731.3, entitled “Cleaning Assembly, Cleaning Device, and Cleaning System” and filed with the China National Intellectual Property Administration on Nov. 15, 2024. The disclosures of the aforementioned applications are hereby incorporated by reference in their entireties.

### TECHNICAL FIELD

The present application relates to the field of cleaning technologies and, in particular, to a cleaning assembly, a cleaning device, and a cleaning system.

### BACKGROUND

A cleaner device in the prior art generally has a mopping module for wet mopping, however, it typically uses room temperature water for mopping, which results in poor effectiveness in removing stubborn stains and oil stains, etc. on the floor; in particular, when room temperature is low, cleaning performance on the floor will be further affected. Therefore, a cleaning capability of the cleaning device needs to be improved.

### SUMMARY

In view of the above shortcomings of the prior art, the present application provides a cleaning assembly, a cleaning device, and a cleaning system to solve the technical problem of poor cleaning performance caused by existing cleaning devices using room temperature water for cleaning.

To achieve the above purposes and other related purposes, the present application provides a cleaning assembly, including: a mop cloth mounting bracket and a mop cloth; the mop cloth is mounted on the mop cloth mounting bracket; where the mop cloth mounting bracket and/or the mop cloth includes a phase-change material, the phase-change material is thermally conductively connected to the mop cloth, such that when the mop cloth is in a non-cleaning operation, the phase-change material absorbs heat from a heat source, and when the mop cloth performs a cleaning operation, the phase-change material releases the heat back to the mop cloth; and the non-cleaning operation includes at least part of a cleaning process, a drying process, or a soaking-and-heating process of the mop cloth.

The beneficial effect of this disposition is: by providing the phase-change material, during a non-cleaning operation process of the cleaning assembly, the mop cloth can be heat through the phase-change material to achieve hot-mopping of the mop cloth, thus, a cleaning effect of the cleaning assembly to the floor may be improved. Meanwhile, since the phase-change material has a high energy density, it may absorb or release large amounts of heat during a phase-change process, and can store a large amount of thermal energy under a relatively small volume or weight. Thus, mounting space occupied on the cleaning assembly may be saved, and overall weight of the cleaning assembly may be reduced. In addition, since the phase-change material only needs to absorb heat from the cleaning solution or the heating member for heating the cleaning solution when cleaning the mop cloth, and no additional heat source needs to be provided for the cleaning assembly, the structure is safer, simpler, and more energy-saving.

In an example of the cleaning assembly of the present application, the heat source includes a heating apparatus and/or hot water.

The beneficial effect of this disposition is: by setting the heat source as the heating apparatus and/or the hot water, heating efficiency of the mop cloth may be improved, and then heat-absorbing efficiency of the phase-change material may be improved, thereby facilitating an improvement of cleaning operation efficiency of the cleaning assembly.

In an example of the cleaning assembly of the present application, a side of the mop cloth mounting bracket away from the mop cloth is provided with a connecting portion that can be detachably connected to a drive assembly, the connecting portion includes a magnetic attraction structure that can be attracted to a drive shaft of the drive assembly, or, the connecting portion includes a snap-fit structure that can be snap-fitted with the drive assembly.

The beneficial effect of this disposition is: by setting the magnetic attraction structure and the snap-fit structure, no other tools are required when mounting the connecting portion and the drive assembly, thus, the mounting and demounting are extremely convenient.

In an example of the cleaning assembly of the present application, an outer periphery of the mop cloth mounting bracket is provided with a buffer portion for absorbing an edge collision force of the cleaning assembly.

The beneficial effect of this disposition is: by disposing the buffer portion on the outer periphery of the mop cloth mounting bracket, on the one hand, the buffer portion may effectively mitigate the collision effect of external collision forces on the cleaning assembly itself, reduce wear on the mop cloth mounting bracket and prolong a service life of the cleaning assembly; and on the other hand, this buffer portion may also reduce scratching and impact on furniture and walls during the cleaning operation process of the mop cloth mounting bracket, thereby decreasing damage degree to furniture and walls, and simultaneously reducing collision noise generated during the cleaning operation process.

In an example of the cleaning assembly of the present application, the buffer portion includes a soft rubber structure, and the soft rubber structure is provided with a plurality of deformable hollowed-out regions.

The beneficial effect of this disposition is: by providing the soft rubber structure and disposing the plurality of deformable hollowed-out regions on the soft rubber structure, the soft rubber structure may be heat-melted and formed onto the outer periphery of the mop cloth mounting bracket. In this disposition, molding and mounting are relatively convenient, and no additional mechanical connection is required. Meanwhile, a structure of the soft rubber structure cooperating with the deformable hollowed-out regions also provides a favorable buffering effect on the outer periphery of the mop cloth mounting bracket.

In an example of the cleaning assembly of the present application, the mop cloth mounting bracket is provided with a sealing cavity, and the sealing cavity is filled with the phase-change material.

The beneficial effect of this disposition is: by providing the sealed cavity to the mop cloth mounting bracket and filling the sealed cavity with the phase-change material, it may not only prevent a leakage probability of the phase change material during the phase-change process, to ensure heat storage performance of the phase-change material, but also reduce an influence of external factors (such as air, moisture, etc.) during the phase-change process, thereby maintaining stability of performance of the phase-change material.

In an example of the cleaning assembly of the present application, the mop cloth mounting bracket is further provided with an opening communicating with the sealing cavity, a liquid phase-change material is injected into the sealing cavity through the opening, and the opening is closed with a sealing cover.

The beneficial effect of this disposition is: by providing the opening, which communicates with the sealed cavity, on the mop cloth mounting bracket, the liquid phase-change material may be injected into the sealed cavity through the opening, thereby the sealed cavity may be manufactured as an integrally molded structure, making it easier to ensure sealing performance of the sealed cavity. Meanwhile, a usage condition of the phase-change material inside the sealed cavity may be convenient viewed through the opening, enabling timely understanding of changes in heat-storage performance of the phase-change material.

In an example of the cleaning assembly of the present application, the mop cloth mounting bracket includes an upper cover body and a lower cover body, and the upper cover body and the lower cover body are sealingly connected to form the sealed cavity; and the mop cloth mounting bracket further includes hot-melt adhesive, and the upper cover body and the lower cover body are hot-melt bonded via the hot-melt adhesive.

The beneficial effect of this disposition is: by providing the upper cover body and the lower cover body, the upper cover body and the lower cover body are connected to form the sealed cavity, this disposition is convenient for a separate design of the mop cloth mounting bracket, facilitates injection molding, and reduces a processing cost. Meanwhile, before closing the upper cover body and the lower cover body, a solid phase-change material may be pre-mounted inside the sealed cavity, then the upper cover body and the lower cover body are connected, to seal the sealed cavity, thereby conveniently a mounting of the solid phase-change material within the sealed cavity. Meanwhile, by providing the hot-melt adhesive to form a fused connection between the upper cover body and the lower cover body, compared with adopting bolt fasteners and other connection manners, this design offers higher connection efficiency in mass production and makes it easier to ensure sealing performance.

In an example of the cleaning assembly of the present application, the lower cover body is thermally connected to the mop cloth, and a thermal conductivity of the lower cover body is greater than a thermal conductivity of the upper cover body.

The beneficial effect of this disposition is: by making the thermal conductivity of the lower cover body greater than the thermal conductivity of the upper cover body, this disposition, on the one hand, provides that the heat stored by the phase-change material may be rapidly conducted through the lower cover body to the mop cloth, thereby heating the mop cloth and improving the heating efficiency and heating effect of the mop cloth; and on the other hand, also reduces the heat transfer from the phase-change material within the sealed cavity to the outside via the upper cover body, thus minimizing heat loss from the phase-change material and further improving the heating effect of the phase-change material on the mop cloth.

In an example of the cleaning assembly of the present application, an adhesive layer is provided on a side of the upper cover body away from the lower cover body.

The beneficial effect of this disposition is: by providing the adhesive layer with a relatively low thermal conductivity on the upper cover body, an exposed surface of the upper cover body may be effectively covered and shielded, thereby reducing a speed of heat exchange between the upper cover body and surrounding air, and reducing the heat transfer from the phase-change material to the outside through the upper cover body. Meanwhile, the adhesive layer may increase friction between the end face of the drive shaft and the mop cloth mounting bracket, thereby facilitating removal of the cleaning assembly.

In an example of the cleaning assembly of the present application, the lower cover includes a thermal conductive rib, at least part of the thermal conductive rib extends into interior of the sealing cavity.

The beneficial effect of this disposition is: by disposing the thermal conductive rib on the lower cover body and ensuring that at least part of the thermal conductive rib extends into the interior of the sealing cavity, a contact area between the phase-change material and the lower cover body may be increased, thereby increasing thermal conduction efficiency between the phase-change material and the lower cover body, and ultimately improving heat transfer efficiency of the phase-change material to the mop cloth to ensure a hot-mopping effect of the mop cloth.

In an example of the cleaning assembly of the present application, the mop cloth includes a fabric layer, a water-absorbing layer, and a bonding layer connected from bottom to top in sequence; a side of the mop cloth mounting bracket facing the mop cloth is provided with an adhesive portion, and the bonding layer is adhesively connected to the adhesive portion; and the phase-change material is disposed between the fabric layer and the water-absorbing layer and/or between the water-absorbing layer and the bonding layer.

The beneficial effect of this disposition is: by disposing the phase-change material between the fabric layer and the water-absorbing layer, and/or between the water-absorbing layer and the bonding layer, in this disposition, when washing the mop cloth, the phase-change material may be fully immersed in the cleaning solution, thus increasing the contact area between the phase-change material and the cleaning solution, thereby improving the heat-storage efficiency of the phase-change material. Meanwhile, when the mop cloth performs a cleaning operation, a thermal conduction path between the phase-change material and the fabric layer is relatively short. Thus, a heat loss during thermal conduction from the phase-change material to the fabric layer may be minimized, thereby facilitating an improvement in the thermal conductivity effect of the phase-change material to the fabric layer, prolonging hot-mopping time of the fabric layer, and further improving the cleaning performance of the mop cloth.

In an example of the cleaning assembly of the present application, a sum of areas of an upper surface and a lower surface of the water-absorbing layer is S1, and an area S2 covered by the phase-change material on the water-absorbing layer is less than or equal to half of S1.

The beneficial effect of this disposition is: the area covered by the phase-change material on the water-absorbing layer is set to be less than or equal to half of S1, within this range, both a water-absorbing performance requirement of the water-absorbing layer may be met to ensure a wet-mopping effect of the mop cloth, and a heat-storage requirement of the phase-change material may also be met to ensure the hot-mopping effect of the mop cloth.

In an example of the cleaning assembly of the present application, a sealed interlayer is provided between the fabric layer and the water-absorbing layer and/or between the water-absorbing layer and the bonding layer; and the phase-change material is filled within the sealed interlayer.

The beneficial effect of this disposition is: by providing the sealed interlayer, it may not only reduce the probability of leakage during the phase-change process of the phase-change material, but also facilitate mounting and fixation of the phase-change material onto the mop cloth, thereby lowering a complexity of mounting process for the phase-change material on the mop cloth.

In an example of the cleaning assembly of the present application, an upper surface and/or a lower surface of the water-absorbing layer is coated with a microcapsule layer, where the microcapsule layer includes a plurality of microcapsules, and the microcapsule is filled with the phase-change material.

The beneficial effect of this disposition is: by disposing the microcapsule layer, and filling the phase-change material inside the microcapsule, in this way, it may not only reduce the probability of leakage of the phase-change material during the phase-change process, but also prevent a microcapsule structure from easily escaping through a stitched pore of the mop cloth, thereby better retaining the phase-change material within the mop cloth and minimizing a loss of the phase-change material during use. Meanwhile, under a same coating area, the microcapsule structure may also increase the contact area between the phase-change material and the cleaning solution, thus facilitating an improvement of the thermal-storage efficiency of the phase-change material.

In an example of the cleaning assembly of the present application, the upper surface of the water-absorbing layer is coated with a plurality of spaced-apart first microcapsule layers, the lower surface of the water-absorbing layer is coated with a plurality of spaced-apart second microcapsule layers, and the plurality of first microcapsule layers and the plurality of second microcapsule layers are disposed in a staggered manner in a vertical direction.

The beneficial effect of this disposition is: on the one hand, the area covered by the microcapsule layer on the water-absorbing layer is maximized while guaranteeing the water-absorption performance requirement of the water-absorbing layer, thereby increasing a usage amount of the phase-change material to ensure the thermal conduction performance of the phase-change material to the fabric layer; and on the other hand, since the first microcapsule layer and the second microcapsule layer are disposed in the staggered manner in the vertical direction, during the mopping process, when the mop cloth is replenished with water, a water flow enters from the upper surface of the water-absorbing layer, bypasses the staggered positions of the first microcapsule layer and the second microcapsule layer, and then flows from the lower surface of the water-absorbing layer to the fabric layer. Thus, a path length of the water flow within the water-absorbing layer may be increased, residence time of the water flow inside the mop cloth may be prolonged and the contact time between the water flow and the phase-change material may be increased, thereby increasing an outlet temperature of the water, and improving the hot-mopping effect of the mop cloth.

In an example of the cleaning assembly of the present application, the phase-change material is a solid-solid phase-change material, and the mop cloth mounting bracket is at least partially composed of the phase-change material.

The beneficial effect of this disposition is: in this disposition, direct contact between the phase-change material and the mop cloth may be achieved, thereby reducing the thermal conduction path between the phase-change material and the mop cloth, and further improving the heating effect of the phase-change material on the mop cloth. Meanwhile, there is no need to additionally provide the phase-change material on the mop cloth mounting bracket, thus, the weight of the mop cloth mounting bracket itself may also be reduced, which facilitates to a lightweight design of the mop cloth mounting bracket.

In an example of the cleaning assembly of the present application, the mop cloth mounting bracket is integrally injection-molded from the phase-change material.

The beneficial effect of this disposition is: in this disposition, a large area and a large weight of the phase-change material may be obtained on the mop cloth mounting bracket, thereby during the cleaning process of the mop cloth, the contact area between the phase-change material and the cleaning solution may be increased to improve the heat-storage efficiency and heat-storage energy of the phase-change material, so that during the cleaning operation with the mop cloth, thermal conduction time from the phase-change material to the mop cloth may be prolonged, and the hot-mopping effect of the mop cloth may be further improved.

In an example of the cleaning assembly of the present application, the mop cloth mounting bracket includes a main body, a side of the main body facing the mop cloth includes the phase-change material, and the phase-change material is at least partially in abutment with the mop cloth.

The beneficial effect of this disposition is: by disposing the phase-change material on the side of the main body facing the mop cloth, this disposition may achieve separate disposition of the main body and the phase-change material, then, a supporting strength of the mop cloth mounting bracket itself can be guaranteed by selecting an appropriate material for the main body, thereby reducing an impact of the phase-change material on the supporting strength of the mop cloth mounting bracket, thus, it facilitates the selection of materials for the phase-change material. Meanwhile, since the main body covers the surface of the side of the phase-change material away from the mop cloth, selecting a material with a lower thermal conductivity for the main body may further improve a heat retention effect of the phase-change material, reducing heat loss of the phase-change material to an external, and facilitating an improvement of the heating efficiency and the heating time provided by the phase-change material to the mop cloth.

In an example of the cleaning assembly of the present application, the mop cloth mounting bracket includes a main body, the main body is made of a metallic material, and the phase-change material encases the main body.

The beneficial effect of this disposition is: by providing the main body made of the metallic material and making the phase-change material encase the metallic material, the main body made of the metallic material may provide better support, thereby improving the supporting strength of the mop cloth mounting bracket. Meanwhile, since the phase-change material encases the metallic material, the metallic material may provide better support to the phase-change material, thus reducing a selecting difficulty in an appropriate phase-change material. Furthermore, by encasing the phase-change material around the outside of the main body, a usage amount of the phase-change material may be increased, which facilitates an improvement of heat-storage performance of the phase-change material, so as to improve the heating effect of the phase-change material on the mop cloth.

The present application further provides a cleaning device, where the cleaning device includes the cleaning assembly described in any of the above examples.

In an example of the cleaning device of present application, the cleaning device includes a body, the cleaning device includes two cleaning assemblies, at least one of the cleaning assemblies is swingably connected to the body to have a retracted position and a swing-out position relative to the body, when the cleaning assembly is in the swing-out position, the cleaning assembly is farther away from the body than being in the retracted position, the cleaning device can perform edge cleaning; and when the mop cloth of the cleaning assembly absorbs heat from the heat source, the cleaning assembly is in the retracted position.

The beneficial effect of this disposition is: since the cleaning assembly has the retracted position and the swing-out position relative to the body, this configuration may achieve an adjustable mounting position of the cleaning assembly relative to the body. This may not only ensure the cleaning effect in the normal cleaning area, but also achieve the edge cleaning within the operation area. Therefore, the cleaning assembly may better meet a requirement of various cleaning conditions, and overall cleaning performance on the floor is better.

The present application further provides a cleaning system, the cleaning system includes the cleaning device described in the above examples and a base station, the base station includes a base, the base is provided with a cleaning tank for accommodating a cleaning solution, where the cleaning tank is provided with a heating apparatus for heating the cleaning solution.

The beneficial effect of this disposition is: since the heating apparatus is disposed within the cleaning tank, a distance between the heating apparatus and the cleaning tank may be shortened, thus reducing heat loss during a transportation process of the cleaning solution. This facilitates an improvement of the heating efficiency of the cleaning solution and contributes to energy conservation and emission reduction. Meanwhile, it also may be achieved that the phase-change material absorbs heat and stores energy during a mop cloth cleaning process, so that during the mop cloth cleaning operation, the stored heat may be transferred to the mop cloth to replenish the heat to the mop cloth, thereby extending the time of hot-water mopping of the mop cloth, and improving the cleaning effect of the mop cloth.

In an example of the cleaning system of present application, the base is provided with a passage for the cleaning device to enter and exit, the cleaning tank includes a front tank portion disposed near the passage and a rear tank portion disposed away from the passage, a height of a bottom wall of the front tank portion is lower than a height of a bottom wall of the rear tank portion, and the heating apparatus is disposed in the front tank portion.

The beneficial effect of this disposition is: by making the height of the bottom wall of the front tank portion lower than the height of the bottom wall of the rear tank portion, and providing the heating apparatus in the front tank portion, the front tank portion may store a larger volume of cleaning solution, thereby achieving a better heating effect and higher heating efficiency of the cleaning solution by the heating apparatus.

In an example of the cleaning system of present application, the base station includes a liquid supply pipeline, the cleaning tank is provided with water spray holes, the water spray holes are connected to the liquid supply pipeline; and a spray direction of the water spray holes is inclined toward the front tank portion, so that a water landing point of the water spray holes is located in the front tank portion.

The beneficial effect of this disposition is: in this disposition, when the cleaning tank is accidentally bumped or needs to be moved, the water spray holes may spray the water toward the front tank portion in time to timely lower a temperature of the front tank portion, and reduce a risk of burns to surrounding objects or personnel.

In an example of the cleaning system of present application, the base station includes a liquid supply pipeline connected to the cleaning tank, the liquid supply pipeline is provided with an instant heating assembly for heating the cleaning liquid, and an outlet of the instant heating assembly is connected to the cleaning tank.

The beneficial effect of this disposition is: the cleaning solution in the cleaning tank may be pre-heated by the instant-heating component, and then the cleaning solution is heated by the heating apparatus. Thus, the cleaning solution in the cleaning tank may be heated twice, so as to improve the heating efficiency of the cleaning solution by the heating apparatus, and reduce a heating temperature of the cleaning solution by the instant-heating component at the same time, thereby reducing the probability of scale inside the instant-heating component due to excessively high temperature, and reducing a maintenance frequency of the instant-heating component.

### BRIEF DESCRIPTION OF DRAWINGS

In order to illustrate the embodiments of the present application or the technical solutions in the prior art more clearly, the drawings needed to be used in the embodiments or the description of the prior art will be introduced briefly in the following. Obviously, the drawings in the following description are some embodiments of the present application. For those of ordinary skill in the art, other embodiments can be obtained from these drawings without paying creative effort.

FIG. 1 is a schematic diagram of an overall structure of an embodiment of a cleaning assembly of the present application.

FIG. 2 is a schematic diagram of a three-dimensional structure of a mop cloth mounting bracket in an embodiment of a cleaning assembly of the present application.

FIG. 3 is a partial cross-sectional view of a phase-change material disposed within a mop cloth mounting bracket in an embodiment of a cleaning assembly of the present application.

FIG. 4 is a schematic structural diagram of a phase-change material disposed within a mop cloth in an embodiment of a cleaning assembly of the present application.

FIG. 5 is an exploded schematic view of a mop cloth in an embodiment of a cleaning assembly of the present application.

FIG. 6 is a schematic structural diagram of a phase-change material disposed in a water-absorbing layer in an embodiment of a cleaning assembly of the present application.

FIG. 7 is a schematic diagram of a three-dimensional structure of a mop cloth mounting bracket in another embodiment of a cleaning assembly of the present application.

FIG. 8 is a schematic diagram of a disposition position of a phase-change material on a mop cloth mounting bracket in another embodiment of a cleaning assembly of the present application.

FIG. 9 is a schematic diagram of an overall structure of an embodiment of a cleaning device of the present application.

FIG. 10 is a schematic diagram of an overall structure of an embodiment of a cleaning system of the present application.

FIG. 11 is a schematic structural diagram of a cleaning assembly accommodated in a cleaning tank in an embodiment of a cleaning system of the present application.

FIG. 12 is a schematic diagram of a partial structure of a cleaning tank on a base in an embodiment of a cleaning system of the present application.

FIG. 13 is a partial enlarged view of an area A in FIG. 12.

FIG. 14 is a schematic structural diagram of a heating apparatus disposed on a back side of a cleaning tank in an embodiment of a cleaning system of the present application.

FIG. 15 is a schematic structural diagram of a cover plate mounted on a back side of a cleaning tank in an embodiment of a cleaning system of the present application.

FIG. 16 is a bottom schematic view of a cleaning assembly in a retracted position in an embodiment of a cleaning device of the present application.

FIG. 17 is a bottom schematic view of a cleaning assembly in a swing-out position of an embodiment of a cleaning device of the present application.

FIG. 18 is a schematic diagram of a three-dimensional structure of a cleaning assembly in a swing-out position in an embodiment of a cleaning device of the present application.

### COMPONENT LABEL DESCRIPTION

10: cleaning assembly; 11: mop cloth mounting bracket; 111: buffer portion; 112: soft rubber structure; 1121: deformable hollowed-out region; 113: sealing cavity; 114: opening; 1141: sealing cover; 115: upper cover body; 1151: adhesive layer; 1152: first annular portion; 1153: second annular portion; 116: lower cover body; 1161: thermal conductive rib; 117: main body; 118: hot-melt adhesive; 12: mop cloth; 121: fabric layer; 122: water-absorbing layer; 123: bonding layer; 124: mounting hole; 13: phase-change material; 14: connecting portion; 141: magnetic attraction structure; 15: adhesive portion; 16: hook-and-loop fastener; 17: microcapsule layer; 171: first microcapsule layer; 172: second microcapsule layer; 20: cleaning device; 21: body; 22: drive assembly; 30: cleaning system; 31: base station; 311: base; 3111: passage; 3112: accommodation cavity; 312: cleaning tank; 3121: front tank portion; 3122: rear tank portion; 3123: water spray hole; 3124: protruding portion; 3125: cleaning rib; 313: cover plate; 314: mounting cavity; 315: base station body; 32: heating apparatus; 321: heating tube; 322: thermal conductive member.

### DESCRIPTION OF EMBODIMENTS

The implementation of the present application is described below through specific examples. Those skilled in the art can readily understand other advantages and effects of the present application from the content disclosed in this specification. The present application may also be implemented or applied through other different specific implementations, and various details in this specification may be modified or changed based on different viewpoints and applications without departing from the spirit of the present application. It should be noted that, the following embodiments and features thereof may be combined with each other when there is no conflict. It should also be understood that the terms used in the embodiments of the present application are intended to describe specific implementation solutions only and are not intended to limit the protect scope of the present application. For test methods in the following embodiments where specific conditions are not indicated, they are generally carried out under conventional conditions or under conditions recommended by the manufacturers.

When numerical ranges are provided in the embodiments, it should be understood that, unless otherwise specified in the present application, both endpoints of each numerical range and any value between the two endpoints may be selected. Unless otherwise defined, all technical and scientific terms used in the present application are based on the knowledge of the prior art by those skilled in the art and the description of the present application, and the present application may also be implemented using any methods, devices, and materials in the prior art similar or equivalent to methods, devices, and materials described in the embodiments of the present application.

It should be noted that the terms such as “upper”, “lower”, “left”, “right”, “middle” and “one” used in this specification are for convenience of description only, and are not intended to limit the scope in which the present application may be implemented. Changes or adjustments to the relative relationships shall be deemed as falling within the scope in which the present application may be implemented, provided that there is no substantial change in the technical content.

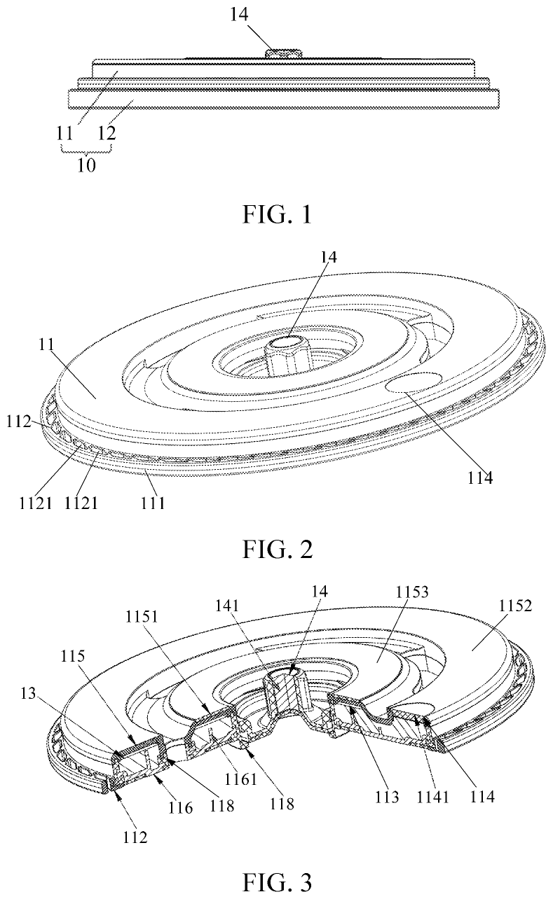

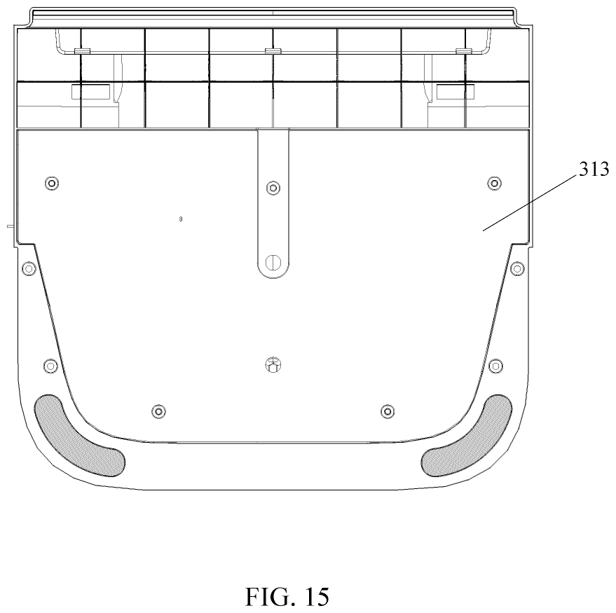

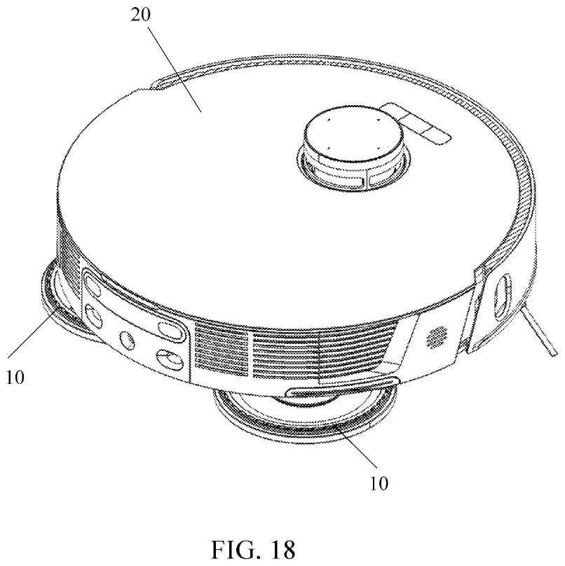

Please refer to FIG. 1 to FIG. 18, the present application provides a cleaning assembly 10, a cleaning device 20, and a cleaning system 30. The cleaning assembly 10 is provided with a phase-change material 13 on a mop cloth mounting bracket 11 and/or a mop cloth 12, and the phase-change material 13 is thermally connected to the mop cloth 12. In this way, during a cleaning process of the mop cloth 12, the phase-change material 13 can absorb and store heat from a heat source, and when the mop cloth 12 performs a cleaning operation, the phase-change material 13 releases the heat to heat the mop cloth 12, thereby achieving hot-mopping with the mop cloth 12. This facilitates removal of stubborn stains, oil stains, etc. from the floor, thus improving cleaning performance of the cleaning assembly 10.

Please refer to FIG. 1 and FIG. 9, the cleaning device 20 provided by the present application includes a body 21 and the cleaning assembly 10.

An interior of the body 21 has an accommodation space to accommodate various components of the cleaning device 20. The body 21 may have any shape, such as a circular shape, an elliptical shape, or a D-shape. The cleaning device 20 may also include a conventional walking assembly disposed on an existing cleaning device 20, the walking assembly is provided at a lower portion of the body 21 to enable the cleaning device 20 to move autonomously. For details on the specific structure of the walking assembly and a connection structure between the walking assembly and the body 21, please refer to the relevant structure descriptions provided in existing cleaning device 20, which are not repeated here.

The cleaning assembly 10 may be detachably connected to the body 21. A detachable connection manner may include a snap-fit detachable connection, a bolted detachable connection, etc. The cleaning assembly 10 is configured as wet mopping, and the body 21 is provided with a water-filling mechanism (not shown in the drawings). An outlet of the water-filling mechanism is connected to the mop cloth 12 to supply liquid to the mop cloth 12 on cleaning assembly 10. The liquid may be a cleaning solution or ordinary tap water, which is determined by a wet-mopping requirement of the cleaning device 20.

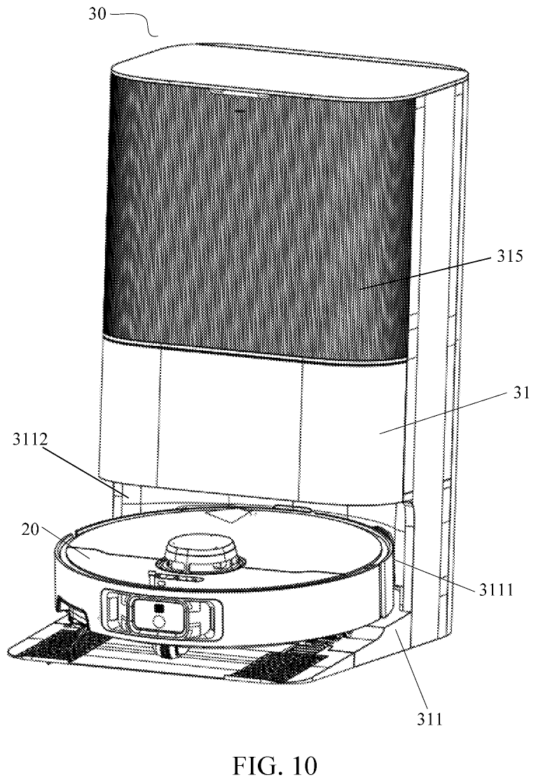

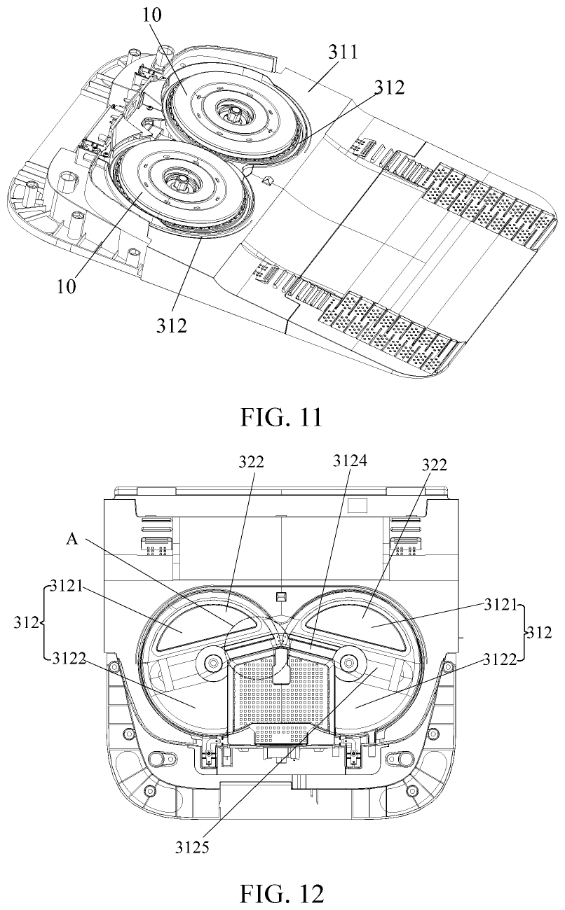

Please refer to FIG. 10 and FIG. 11, the cleaning device 20 is provided with a corresponding base station 31, and the base station 31 is provided with a cleaning structure. The cleaning structure may be an existing cleaning tank structure or any other structure which can accommodate the cleaning solution and clean the mop cloth 12. During a cleaning operation, the cleaning device 20 may return to the base station 31 multiple times to clean the cleaning assembly 10. The base station 31 is provided with a heating apparatus that can heat the cleaning solution accommodated in the cleaning structure, thereby achieving hot cleaning of the cleaning assembly 10 to enhance cleaning effect of the cleaning assembly 10.

Please refer to FIG. 1, FIG. 2, FIG. 3, and FIG. 9. In an embodiment of the present application, the cleaning assembly 10 includes the mop cloth mounting bracket 11 and the mop cloth 12. The mop cloth mounting bracket 11 is mounted at a lower portion of the body 21, and the mop cloth 12 is mounted on the mop cloth mounting bracket 11. The mop cloth mounting bracket 11 may be detachably connected or fixedly connected with the mop cloth 12. The mop cloth 12 may be a circular mop cloth, a rectangular mop cloth, a polygonal mop cloth, etc. In this embodiment, for ease of description, the mop cloth 12 is the circular mop cloth. The circular mop cloth means that a cleaning operation surface between the mop cloth 12 and the ground has a circular contour.

It should be noted that a number of cleaning assemblies 10 disposed on the cleaning device 20 may be either one set or multiple sets, depending specifically on a cleaning area and a cleaning efficiency requirement of the cleaning device 20. In this embodiment, please refer to FIG. 9 and FIG. 11, the cleaning device 20 is provided with two sets of cleaning assemblies 10, which are symmetrically mounted at a bottom of the body 21 to achieve a floor cleaning operation during a movement process of the cleaning device 20.

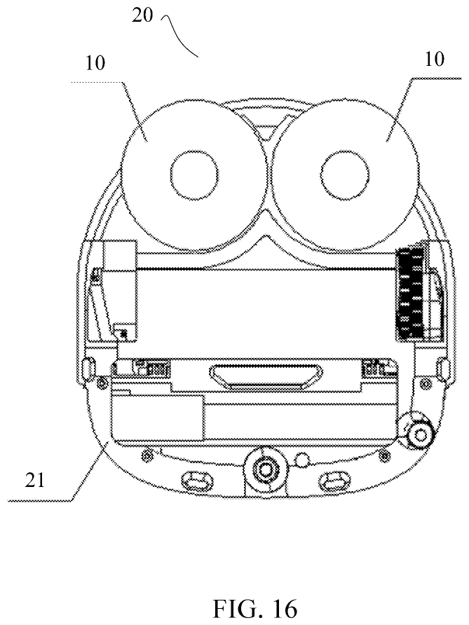

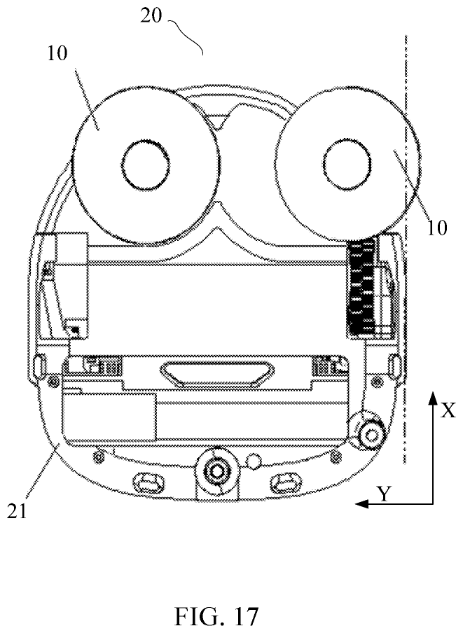

Please refer to FIG. 16 to FIG. 18. In an example of the cleaning device 20 of the present application, the cleaning device 20 includes two cleaning assemblies 10 which are movably connected to the body 21, the “movably connected to the body 21” means that the cleaning assembly 10 is rotatable about a rotation axis to achieve rotational cleaning; where the two cleaning assemblies 10 are swingably connected to the body 21, or, one of the cleaning assemblies 10 is swingably connected to the body 21, “swingably connected to the body 21” means that the rotation axis of the cleaning assembly 10 is adjustable in a planar position relative to the body 21, so that the cleaning assembly 10 has both a retracted position and a swing-out position relative to the body 21. A movement direction of the body 21 is defined as a length direction of the body 21 (an X-axis as shown in FIG. 17), a direction perpendicular to the movement direction of the body 21 is defined as a width direction of the body 21 (a Y-axis as shown in FIG. 17). When the cleaning assembly 10 is in the swing-out position, compared to being in the retracted position, the rotational axis of the cleaning assembly 10 moves outward along the width direction of the body 21, thereby achieving the edge cleaning of the cleaning device 20. When the cleaning assembly 10 is in the retracted position, the rotational axis of the cleaning assembly 10 moves inward along the width direction of the body 21, so that the two cleaning assemblies 10 to move closer together to ensure the cleaning effect within an operation area between the two cleaning assemblies 10. It should be noted that the specific structures of the retracted position and the swing-out position which can be achieved by the cleaning assembly 10 and the body 21 may refer to the relevant structural descriptions in the existing cleaning device 20, which are not repeated here.

When the mop cloth 12 of the cleaning assembly 10 needs to absorb heat from the heat source, the cleaning assembly 10 is in the retracted position at this time, thereby reducing an accommodation space occupied by the cleaning device 20 during a cleaning process of the mop cloth 12 and facilitating the cleaning device 20 entering and exiting the base station 31.

Since the cleaning assembly 10 has the retracted position and the swing-out position relative to the body 21, this configuration may achieve an adjustable mounting position of the cleaning assembly 10 relative to the body 21. This not only ensures the cleaning effect in an area between the two cleaning assemblies 10 but also achieves the edge cleaning within the operation area. Therefore, the cleaning assembly 10 may better meet a requirement of various cleaning conditions, thereby facilitating an improvement in all-around cleaning performance on the floor.

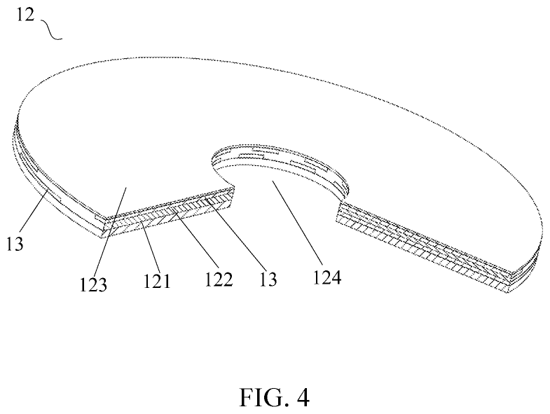

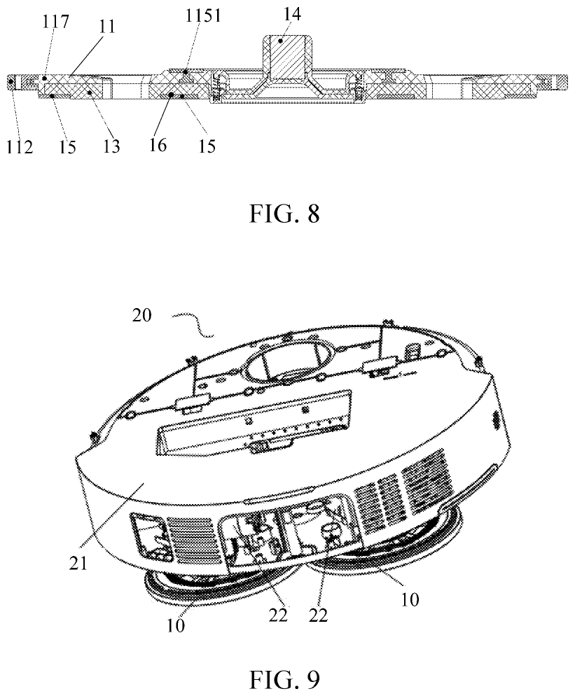

Please refer to FIG. 3, FIG. 4, and FIG. 8, the mop cloth mounting bracket 11 includes a phase-change material 13 which is thermally conductively connected to the mop cloth 12. The phase-change material 13 may be a solid-liquid phase-change material, that is, it may transition between a solid state and a liquid state within a certain temperature range. When the phase-change material 13 transitions from the solid to the liquid, it absorbs heat; and when it transitions from the liquid to the solid, it releases the heat. The phase-change material 13 may also be a solid-solid phase-change material, that is, it undergoes a phase change between two solid states. When the phase-change material 13 transitions from a first solid state to a second solid state, it absorbs the heat; and when it transitions from the second solid state to the first solid state, it releases the heat. Through state change of the phase-change material 13, the mop cloth mounting bracket 11 transitions between heat absorption and heat release.

It should be noted that when the phase-change material 13 is the solid-liquid phase-change material, the phase-change material 13 needs to be mounted within a sealed cavity. When the phase-change material 13 is the solid-solid phase-change material, the phase-change material 13 does not need to be mounted within the sealed cavity.

Under a condition that a thermal conduction requirement between the phase-change material 13 and the mop cloth 12 is satisfied, the phase-change material 13 may be disposed on a side of the mop cloth mounting bracket 11 facing the mop cloth 12, thereby enabling the phase-change material 13 to directly contact with the mop cloth 12 for thermal conduction, as shown in FIG. 8. The phase-change material 13 may also be disposed within the sealed cavity in the mop cloth mounting bracket 11, and achieve indirect thermal conduction between the phase-change material 13 and the mop cloth 12 through other thermal conductive members, as shown in FIG. 3. In another embodiment, the mop cloth 12 may include the phase-change material 13, that is, the phase-change material 13 is disposed on the mop cloth 12, as shown in FIG. 4. In other embodiments, the mop cloth mounting bracket 11 may include a portion of the phase-change material 13, and the mop cloth 12 may also include a portion of the phase-change material 13, that is, part of the phase-change material 13 is disposed on the mop cloth mounting bracket 11 and another part thereof is disposed on the mop cloth 12. In actual design and manufacturing processes, as for the specific disposition position of the phase-change material 13, it also needs to consider various factors, including a production process condition, a production cost, and a heat absorption requirement of the mop cloth 12.

When the mop cloth 12 is in a non-cleaning operation, the phase-change material 13 absorbs heat from the heat source to store the heat; and when the mop cloth 12 performs the cleaning operation, the phase-change material 13 releases the heat to the mop cloth 12 for performing heat conduction on the mop cloth 12, so as to achieve hot mopping with the mop cloth 12. In this embodiment, the heat source may be the cleaning solution with a certain temperature, a heating member that heats the cleaning solution, or a combination of the cleaning solution and the heating member. The non-cleaning operations includes at least part of a cleaning process, a drying process, and a soaking-and-heating process of the mop cloth 12. For example, in an embodiment, the non-cleaning operation may be any single one of the following processes: the cleaning process, the drying process, or the soaking-and-heating process of the mop cloth 12. In another embodiment, the non-cleaning operation may also be a combination of two or three of these processes: the cleaning process, the drying process, or the soaking-and-heating process of the mop cloth 12.

By providing the phase-change material 13, the cleaning assembly 10 can heat the mop cloth 12 during a non-cleaning operation process through the phase-change material 13 to achieve the hot mopping with the mop cloth 12, and thus the cleaning effect of the cleaning assembly 10 on the floor may be improved. Meanwhile, since the phase-change material 13 has a high energy density, it may absorb or release large amounts of heat during a phase-change process, and can store a large amount of thermal energy under a relatively small volume or weight. Thus, mounting space occupied on the cleaning assembly 10 may be saved, and overall weight of the cleaning assembly 10 may be reduced. In addition, since the phase-change material 13 only needs to absorb the heat during at least part of the cleaning process, the drying process, or the soaking-and-heating process of the mop cloth 12, compared with the technical solution in the prior art that an active heating apparatus is disposed on the body of the cleaning device to heat the mop cloth, this embodiment does not require an additional heating source on the cleaning device 20. In this way, a circuit design inside the cleaning device 20 is simplified, and an internal structure in the cleaning device 20 is simplified. Consequently, the overall structure of the cleaning device 20 in this embodiment is electrically safer, thereby reducing a probability of circuit failure during use of the cleaning device 20.

In an example of the cleaning assembly 10 of the present application, the heat source includes a heating apparatus 32. The heating apparatus 32 may be disposed in a cleaning tank 312 of the base station 31, or may be disposed outside the base station 31. As long as the heating apparatus 32 can heat the mop cloth 12 when the mop cloth 12 is in the non-cleaning operation, and the phase-change material 13 can absorb the heat. In another embodiment, the heat source may also be hot water, the hot water may be heated cleaning solution in the cleaning tank 312. That is, when the mop cloth 12 contacts with the cleaning solution in the cleaning tank 312, the phase-change material 13 can absorb the heat from the cleaning solution. The hot water may also be a liquid contained in a container located outside the base station 31, the liquid may be plain water, or may be the cleaning solution. When the mop cloth 12 is soaked in the hot water in the container and heated, the phase-change material 13 may also absorb the heat from the hot water. In other embodiments, the heat source may be a combination of the heating apparatus 32 and the hot water, for example, the heating apparatus 32 is disposed inside the cleaning tank 312 and simultaneously filling the cleaning tank 312 with heated cleaning solution (i.e., hot water). Once the mop cloth 12 enters the cleaning tank 312, the mop cloth 12 may contact with both the heating apparatus 32 and the cleaning solution, thereby the phase-change material 13 may absorb the heat from both the heating apparatus 32 and the cleaning solution at the same time.

By setting the heat source as the heating apparatus 32 and/or the hot water, the heating efficiency of the mop cloth 12 may be improved, and then heat-absorbing efficiency of the phase-change material 13 may be improved, thereby facilitating improvement of efficiency of the cleaning operation of the cleaning assembly 10.

Considering convenience of connecting the cleaning assembly 10 to a drive assembly 22 of the cleaning device 20, in an embodiment, please refer to FIG. 2, FIG. 3 and FIG. 9. In an example of the cleaning assembly 10 of the present application, a connecting portion 14, detachably connected to the drive assembly 22, is provided at a side of the mop cloth mounting bracket 11 away from the mop cloth 12. Specifically, the connecting portion 14 is connected to a drive shaft of the drive assembly 22, so that when the drive assembly 22 is operating, the connecting portion 14 drives the cleaning assembly 10 to perform the cleaning operation. The connecting portion 14 may be a protruding post structure or a recessed groove structure, as long as the connecting portion 14 can be properly matched with the drive shaft of the drive assembly 22. The connecting portion 14 includes a magnetic attraction structure 141 that can be attracted to the drive shaft of the drive assembly 22. The magnetic attraction structure 141 may have various forms. In an embodiment, the magnetic attraction structure 141 is a magnet, that is, the connecting portion 14 includes the magnet, at this time, the drive shaft is a ferromagnetic, the connecting portion 14 is in magnetic attraction connection with the drive shaft to achieve an axially fixed connection between the connecting portion 14 and the drive shaft. In another embodiment, the magnetic attraction structure 141 may also be a ferromagnetic, that is, the connecting portion 14 includes the ferromagnetic, at this time, the drive shaft is the magnet, magnetic attraction connection may be achieved between the connecting portion 14 and the drive shaft. In other embodiments, the magnetic attraction structure 141 may be the magnet, that is, the connecting portion 14 includes the magnet, at this time, the drive shaft is also the magnet, and magnetic polarities of the connecting portion 14 and the drive shaft are opposite, in this way, the magnetic attraction connection between the connecting portion 14 and the drive shaft also may be achieved.

By providing the magnetic attraction structure 141, no other tools are required when mounting the connecting portion 14 and the drive assembly 22, thus, the mounting is extremely convenient. Meanwhile, when detaching the connecting portion 14 from the drive assembly 22, it is only required to apply a pulling force greater than a magnetic attraction force to a side of the connecting portion 14, thus, a detachment process is relatively convenient.

In another example of the cleaning assembly 10 of the present application, the connecting portion 14 includes a snap-fit structure (not shown in the drawings) that can be snap-fitted with the drive assembly 22. The snap-fit structure may have various forms, for example, the snap-fit structure may be a tapered hole structure, at this time, the drive shaft of the drive assembly 22 is a tapered boss structure. By snapping a tapered boss into a tapered hole to form a tapered snap-fit connection, thereby achieving a snap-fit connection between the connecting portion 14 and the drive assembly 22. The snap-fit structure may also be a plurality of wedge-shaped blocks disposed on an outer periphery of the connecting portion 14, at this time, the drive shaft of the drive assembly 22 is provided with a groove structure. The connecting portion 14 is inserted into the groove, and the plurality of wedge-shaped blocks respectively abut against side walls of the groove along a circumferential direction of the drive shaft, forming a frictional abutment, thereby achieving the snap-fit connection between the connecting portion 14 and the drive assembly 22. By providing the snap-fit structure on the connecting portion 14, the assembly and disassembly between the connecting portion 14 and the drive assembly 22 may also be conveniently achieved. To reduce a collision impact force generated when the cleaning assembly 10 contacts surrounding obstacles during the cleaning operation, please refer to FIG. 2 and FIG. 3, in an example of the cleaning assembly 10 of the present application, a buffer portion 111 is provided on the outer periphery of the mop cloth mounting bracket 11 for absorbing an edge collision force of the cleaning assembly 10. The buffer portion 111 may be an annular structure made of a plastic material or silicone material with a certain degree of flexibility. When the annular structure is subjected to a collision, the annular structure may absorb a collision force through its own elastic-plastic deformation to provide a buffering effect. The buffer portion 111 may also be an elastic structure disposed on the outer periphery of the mop cloth mounting bracket 11, for example, a combined structure of a spring and a baffle plate. When the baffle plate is subjected to the collision, the spring absorbs the collision force by telescopic deformation, thus providing a buffer effect. By providing the buffer portion 111 on the outer periphery of the mop cloth mounting bracket 11, on the one hand, the buffer portion 111 may effectively mitigate the collision effect of external collision forces on the cleaning assembly 10 itself, reduce wear on the mop cloth mounting bracket 11 and prolong a service life of the cleaning assembly 10; and on the other hand, the buffer portion 111 may also reduce scratching and impact on furniture and walls during the cleaning operation process of the mop cloth mounting bracket 11, thereby decreasing damage degree to furniture and walls, and simultaneously reducing collision noise generated during the cleaning operation process.

Please refer to FIG. 2 and FIG. 3, in an example of the cleaning assembly 10 of the present application, the buffer portion 111 includes a soft rubber structure 112, the soft rubber structure 112 is provided with a plurality of deformable hollowed-out regions 1121. A material of the soft rubber structure 112 may be silicone, rubber, etc. The soft rubber structure 112 may be an annular structure disposed around an entire circumference the outer periphery of the mop cloth mounting bracket 11, or may be a plurality of spaced-apart block structures. The deformable hollowed-out regions 1121 provided on the soft rubber structure 112 may have various shape structures, such as circular holes, square holes, or polygonal holes. In an embodiment, in order to achieve a uniform buffering effect in the circumferential direction of the mop cloth mounting bracket 11, the soft rubber structure 112 is an annular structure coaxially arranged with the mop cloth mounting bracket 11, and multiple deformable hollowed-out regions 1121 are arranged in an array on the annular structure. By providing the soft rubber structure 112 and disposing the plurality of deformable hollowed-out regions 1121 on the soft rubber structure 112, the soft rubber structure 112 may be heat-melted and formed onto the outer periphery of the mop cloth mounting bracket 11. In this disposition, molding and mounting are relatively convenient, and no additional mechanical connection is required. Meanwhile, a structure of the soft rubber structure 112 cooperating with the deformable hollowed-out regions 1121 also provides a favorable buffering effect on the outer periphery of the mop cloth mounting bracket.

Considering that commonly used phase-change material 13 is generally the solid-liquid phase-change material, thus, during the phase-change process when the phase-change material 13 transitions from the solid state to the liquid state, a leakage issue of the phase-change material 13 needs to be considered. Based on this, in an embodiment, please refer to FIG. 3, in an example of the cleaning assembly 10 of the present application, the mop cloth mounting bracket 11 is provided with a sealing cavity 113 which is filled with the phase-change material 13. The sealing cavity 113 may be an integral annular cavity structure surrounding the mop cloth mounting bracket 11, or may be a plurality of locally cavity structures spaced-apart. The specific structure of the sealing cavity 113 needs be determined according to a structural shape of the mop cloth mounting bracket 11. The phase-change material 13 may fill the whole sealing cavity 113 or partially fill the sealing cavity 113. There are various ways to form the sealing cavity 113, for example, the sealing cavity 113 may be formed by integrally injection-molding the mop cloth mounting bracket 11, or the mop cloth mounting bracket 11 may be divided into upper and lower portions that are assembled together to form the sealing cavity 113, which is not limited in the embodiment. It should be noted that a side of the sealing cavity 113 facing the mop cloth 12 needs to have better thermal conduction performance to ensure that the heat from the phase-change material 13 within the sealed cavity 113 can be efficiently transferred to the mop cloth 12, thereby heating the mop cloth 12. In addition, in other embodiments, when the phase-change material 13 is the solid-solid phase-change material, the phase-change material 13 may also be disposed directly within the sealed cavity 113. By providing the sealed cavity 113 to the mop cloth mounting bracket 11 and filling the sealed cavity 113 with the phase-change material 13, it may not only prevent a leakage probability of the phase change material 13 during the phase-change process, to ensure heat storage performance of the phase-change material 13, but also reduce an influence of external factors (such as air, moisture, etc.) during the phase-change process, thereby maintaining stability of performance of the phase-change material 13.

There are several manners to fill the phase-change material 13 into the sealed cavity 113. In an example of the cleaning assembly 10 of the present application, please refer to FIG. 3, the mop cloth mounting bracket 11 is provided with an opening 114, the opening 114 communicates with the sealed cavity 113, and a liquid phase-change material 13 is injected into the sealed cavity 113 through the opening 114. The opening 114 may be disposed at multiple positions, such as, on an upper surface, a lower surface, or a side surface of the mop cloth mounting bracket 11. The opening 114 may a single or multiple. When the sealed cavity 113 is an integral cavity structure, only one opening 114 may be disposed. However, if the sealed cavity 113 is multiple non-communicating cavity structures, at this time, at least one opening 114 needs be provided for each cavity structure. The opening 114 may be any shape structure that can meet a filling requirement of the liquid phase-change material 13, such as a circular hole structure, a square hole structure, or an irregular-shaped hole structure. Preferably, in this embodiment, the sealed cavity 113 is an integral cavity structure, a side of the mop cloth mounting bracket 11 away from the mop cloth 12 is provided with an opening 114 that communicates with the sealed cavity 113. The opening 114 is closed with a sealing cover 1141. The sealing cover 1141 may be detachably closed over the opening 114, for example, by a sealed threaded connection. The sealing cover 1141 may be non-detachably closed over the opening 114, for example, by adhesive bonding on the opening 114 or by heat fusion to the opening 114. By providing the opening 114, which communicates with the sealed cavity 113, on the mop cloth mounting bracket 11, the liquid phase-change material 13 may be injected into the sealed cavity 113 through the opening 114, thereby the sealed cavity 113 may be manufactured as an integrally molded structure, making it easier to ensure sealing performance of the sealed cavity 113. Meanwhile, a usage condition of the phase-change material inside the sealed cavity 113 may be convenient viewed through the opening 114, enabling timely understanding changes in heat-storage performance of the phase-change material 13.

Please refer to FIG. 3, in an example of the cleaning assembly 10 of the present application, the mop cloth mounting bracket 11 includes an upper cover body 115 and a lower cover body 116. The upper cover body 115 and the lower cover body 116 are sealingly connected to form the sealed cavity 113. The lower cover body 116 is disposed near a side of the mop cloth 12 and is connected to the mop cloth 12. A connection between the upper cover body 115 and the lower cover body 116 may be achieved by using bolts and other fasteners in combination with sealing elements to ensure a sealed connection therebetween. The upper cover body 115 and the lower cover body 116 may also be hot-melt connected via hot-melt adhesive to achieve the sealed connection therebetween. A forming structure of the sealed cavity 113 is not limited, for example, the upper cover body 115 may be provided with a groove, and the lower cover body 116 seals a groove opening to form the sealed cavity 113; or the lower cover body 116 may be provided with a groove, and the upper cover body 115 seals a groove opening to form the sealed cavity 113. By providing the upper cover body 115 and the lower cover body 116, the upper cover body 115 and the lower cover body 116 are connected to form the sealed cavity 113, this disposition is convenient for a separate design of the mop cloth mounting bracket 11, facilitates injection molding, and reduces a processing cost. Meanwhile, before closing the upper cover body 115 and the lower cover body 116, a solid phase-change material 13 may be pre-mounted inside the sealed cavity 113, then the upper cover body 115 and the lower cover body 116 are connected, to seal the sealed cavity 113, thereby conveniently mounting the solid phase-change material 13 within the sealed cavity 113.

Although there are various connection manners between the upper cover body 115 and the lower cover body 116, considering assembly efficiency of the mop cloth mounting bracket 11, preferably, in an example of the cleaning assembly 10 of the present application, please refer to FIG. 3, the mop cloth mounting bracket 11 further includes a hot-melt adhesive 118, the upper cover body 115 and the lower cover body 116 are hot-melt bonded via the hot-melt adhesive 118. The hot-melt adhesive 118 may be an EVA hot-melt adhesive, a PUR hot-melt adhesive and other types. In actual usage process, the specific type needs to be determined according to materials of the upper cover body 115 and the lower cover body 116 as well as a connection performance requirement. The hot-melt adhesive 118 is disposed at a butt joint between the upper cover body 115 and the lower cover body 116, that is, both sides of the hot-melt adhesive 118 are in contact with the upper cover body 115 and the lower cover body 116, respectively. When the upper cover body 115 and the lower cover body 116 need to be connected, the hot-melt adhesive 118 is heated to be fused, at the same time, a butt pressure is applied between the upper cover body 115 and the lower cover body 116 until the hot-melt adhesive 118 cools and solidifies again, thereby achieving a sealed and fixed connection between the upper cover body 115 and the lower cover body 116. By providing the hot-melt adhesive 118 to form a fused connection between the upper cover body 115 and the lower cover body 116. Compared with adopting bolt fasteners and other connection manners, this design offers higher connection efficiency in mass production and makes it easier to ensure sealing performance.

To further improve the thermal conduction performance between the phase-change material 13 and the mop cloth 12, in an embodiment, please refer to FIG. 3, in an example of the cleaning assembly 10 of the present application, the lower cover body 116 is thermally connected to the mop cloth 12. That is, the mop cloth 12 is mounted on the lower cover body 116 and thermally connected to a surface of the lower cover body 116 away from the upper cover body 115. A thermal conductivity of the lower cover body 116 is greater than a thermal conductivity of the upper cover body 115. For example, the lower cover body 116 may be a metallic material, and the upper cover body 115 may be a plastic material, thereby achieving that the thermal conductivity of the lower cover body 116 is greater than the thermal conductivity of the upper cover body 115. The upper cover body 115 may also be common plastic materials with low thermal conductivity, such as polyethylene or polypropylene, and the lower cover body 116 may be a modified plastic material with high thermal conduction performance, with metallic materials added, so that the thermal conductivity of the lower cover body 116 is greater than the thermal conductivity of the upper cover body 115. By making the thermal conductivity of the lower cover body 116 greater than the thermal conductivity of the upper cover body 115, this disposition, on the one hand, provides that the heat stored by the phase-change material 13 may be rapidly conducted through the lower cover body 116 to the mop cloth 12, thereby heating the mop cloth 12 and improving the heating efficiency and heating effect of the mop cloth 12; and on the other hand, also reduces the heat transfer from the phase-change material 13 within the sealed cavity 113 to the outside via the upper cover body 115, thus minimizing heat loss from the phase-change material 13 and further improving the heating effect of the phase-change material on the mop cloth 12.

To further reduce the heat transfer from phase-change material 13 to the outside through the upper cover body 115, preferably, in an example of the cleaning assembly 10 according to the present application, please refer to FIG. 3, an adhesive layer 1151 is provided on a side of the upper cover body 115 away from the lower cover body 116. The adhesive layer 1151 may coat an entire upper surface of the upper cover body 115, or only partially coat the upper surface of the upper cover body 115. By coating the adhesive layer 1151 with a relatively low thermal conductivity on the upper cover body 115, an exposed surface of the upper cover body 115 may be effectively covered and shielded, thereby reducing a speed of heat exchange between the upper cover body 115 and surrounding air, and reducing the heat transfer from the phase-change material 13 to the outside through the upper cover body 115. Specifically, in this embodiment, the upper surface of the upper cover body 115 includes a first annular portion 1152 and a second annular portion 1153 arranged coaxially. The first annular portion 1152 and the second annular portion 1153 protrude toward the side away from the lower cover body 116. The first annular portion 1152 is located the outer periphery of the upper cover body 115, the second annular portion 1153 is disposed between the connecting portion 14 and the first annular portion 1152, and is disposed near a side of the connecting portion 14. The adhesive layer 1151 coats a surface of the second annular portion 1153 away from the lower cover body 116. This setting manner reduces the heat transfer from the phase-change material 13 to the outside through the upper cover body 115. Meanwhile, since the second annular portion 1153 is located near the connecting portion 14, when the cleaning assembly 10 is mounted, the second annular portion 1153 will be in abutment with an end face of the drive shaft of the drive assembly. Thus, when the cleaning assembly 10 needs to be removed, the adhesive layer 1151 may increase friction between the end face of the drive shaft and the mop cloth mounting bracket 11, thereby facilitating removal of the cleaning assembly 10.

Please refer to FIG. 3, in an example of the cleaning assembly 10 of the present application, the lower cover body 116 includes a thermal conductive rib 1161, at least part of the thermal conductive rib 1161 extends into interior of the sealing cavity 113. A material of the thermal conductive rib 1161 may be the same as the material of the lower cover body 116, for example, the material may be a metallic material with good thermal conductivity, or may be a plastic material with good thermal conductivity, etc. The material of the thermal conductive rib 1161 may also differ from the material the lower cover body 116, for example, the thermal conductive rib 1161 is the metallic material and the lower cover body 116 is the plastic material. The thermal conductive rib 1161 may be integrally formed and connected to the lower cover body 116, or they may be assembled separately, provided that a thermally conductive connection between the thermal conductive rib 1161 and the lower cover body 116 meets a requirement. A shape of the thermal conductive ribs 1161 within the sealing cavity 113 may be multiple spaced triangular rib structures, or an integral annular thin-walled structure, or multiple spaced strip-shaped ribs, and so on. By disposing the thermal conductive rib 1161 on the lower cover body 116 and ensuring that at least part of the thermal conductive rib 1161 extends into the interior of the sealing cavity 113, a contact area between the phase-change material 13 and the lower cover body 116 may be increased, thereby increasing thermal conduction efficiency between the phase-change material 13 and the lower cover body 116, and ultimately improving heat transfer efficiency of the phase-change material 13 to the mop cloth 12 to ensure a hot-mopping effect of the mop cloth 12.

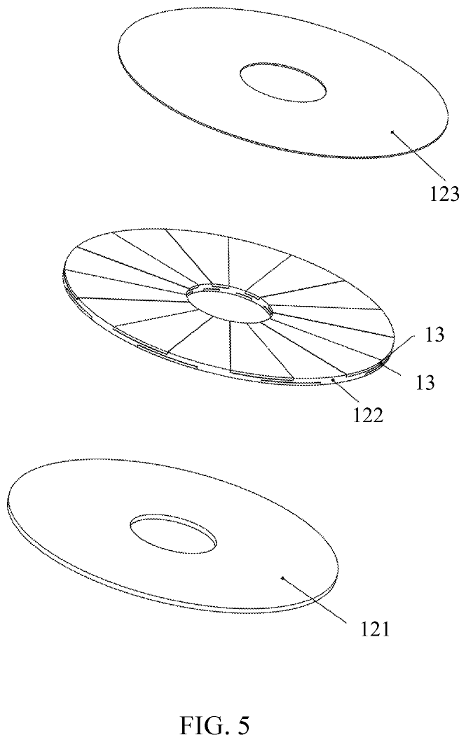

Please refer to FIG. 4 and FIG. 5, in an example of the cleaning assembly 10 of the present application, the mop cloth 12 includes a fabric layer 121, a water-absorbing layer 122, and a bonding layer 123 connected from bottom to top in sequence. The fabric layer 121, the water-absorbing layer 122, and the bonding layer 123 may be connected by various manners, such as an adhesive bonding connection or a stitching connection. In this embodiment, the fabric layer 121, the water-absorbing layer 122, and the bonding layer 123 are connected by stitching to form the mop cloth 12. Stitching features low cost, simple operation and high efficiency. The fabric layer 121, the water-absorbing layer 122, and the bonding layer 123 are a disk-shaped structure arranged coaxially, and outer diameters of them are substantially identical. A mounting hole 124 for connecting to the mop cloth mounting bracket 11 is provided in a central region of the mop cloth 12. The mounting hole 124 extends through the fabric layer 121, the water-absorbing layer 122, and the bonding layer 123 along a thickness direction of the mop cloth 12. The fabric layer 121 is used for mopping the floor and holding dirt, the fabric layer 121 may be any fabric that can mop, such as a cotton cloth, a fiber cloth, or a non-woven fabric. The water-absorbing layer 122 may be the material such as a sponge or a highly water-absorbent cotton cloth, which stores some moisture in the mop cloth 12 to achieve wet mopping with the mop cloth 12. Please refer to FIG. 4 and FIG. 8, a side of the mop cloth mounting bracket 11 facing the mop cloth 12 is provided with an adhesive portion 15, and the bonding layer 123 is adhesively connected to the adhesive portion 15. The adhesive portion 15 may be an adhesive agent, and the bonding layer 123 is adhered to the adhesive portion 15 via adhesive bonding to achieve a fixed connection between the mop cloth mounting bracket 11 and the mop cloth 12. The adhesive portion 15 may be a hook-and-loop fastener, the bonding layer 123 is a hook fabric that can adhere to the hook-and-loop fastener. The bonding layer 123 is adhered to the hook-and-loop fastener to achieve a fixed connection between the mop cloth mounting bracket 11 and the mop cloth 12.

Please refer to FIG. 4 and FIG. 5, the phase-change material 13 is disposed between the fabric layer 121 and the water-absorbing layer 122. The phase-change material 13 may be sandwiched and fixed between the fabric layer 121 and the water-absorbing layer 122, or may be adhered and fixed to the fabric layer 121 or the water-absorbing layer 122. In another embodiment, the phase-change material 13 may also be disposed between the water-absorbing layer 122 and the bonding layer 123. In other embodiments, the phase-change material 13 may partially disposed between the fabric layer 121 and the water-absorbing layer 122, and partially disposed between the water-absorbing layer 122 and the bonding layer 123. It should be noted that, as for a disposing area of the phase-change material 13 on the mop cloth 12, it not only needs to consider the heat-storage requirement of the phase-change material 13, but also needs to ensure a water-absorption requirement of the water-absorbing layer 122. That is, the phase-change material 13 cannot completely cover and block a water-absorbing surface of the water-absorbing layer 122, a portion of the area needs to be reserved to allow the water-absorbing layer 122 to perform normal water absorption. A specific size of a coverage area of the phase-change material 13 on the water-absorbing layer 122 needs to be obtained by calculation according to actual water absorption amount of the mop cloth 12 and the heat-storage requirements of the phase-change material 13.

By disposing the phase-change material 13 between the fabric layer 121 and the water-absorbing layer 122, and/or between the water-absorbing layer 122 and the bonding layer 123, in this disposition, when washing the mop cloth 12, the phase-change material 13 may be fully immersed in the cleaning solution, thus increasing the contact area between the phase-change material 13 and the cleaning solution, thereby improving the heat-storage efficiency of the phase-change material 13. Meanwhile, when the mop cloth 12 performs a cleaning operation, a thermal conduction path between the phase-change material 13 and the fabric layer 121 is relatively short. Thus, a heat loss during thermal conduction from the phase-change material 13 to the fabric layer 121 may be minimized, thereby facilitating an improvement in the thermal conductivity effect of the phase-change material 13 to the fabric layer 121, prolonging hot-mopping time of the fabric layer 121, and further improving the cleaning performance of the mop cloth 12.

Please refer to FIG. 4 and FIG. 5, in an example of the cleaning assembly 10 of the present application, a sum of areas of an upper surface and a lower surface of the water-absorbing layer 122 is S1. The upper surface of the water-absorbing layer 122 refers to a surface of a side of the water-absorbing layer 122 facing the bonding layer 123, and the lower surface of the water-absorbing layer 122 refers to a surface of a side of the water-absorbing layer 122 facing the fabric layer 121. An area S2 covered by the phase-change material 13 on the water-absorbing layer 122 is less than or equal to half of S1. The phase-change material 13 may be disposed only on the upper surface of the water-absorbing layer 122, or only on the lower surface of the water-absorbing layer 122, or the phase-change material 13 may also be disposed at intervals on the upper surface or the lower surface, as long as the area S2 covered by the phase-change material 13 on the water-absorbing layer 122 is less than or equal to half of S1.

When the phase-change material 13 is disposed on the upper surface of the water-absorbing layer 122, the phase-change material 13 will cover the upper surface of the water-absorbing layer 122. When the phase-change material 13 is disposed on the lower surface of the water-absorbing layer 122, the phase-change material 13 will cover the lower surface of the water-absorbing layer 122. The larger the area of the water-absorbing layer 122 covered by the phase-change material 13, the weaker the water-absorbing performance of the water-absorbing layer 122, but the better the heat-storage performance of the phase-change material 13. In contrast, the smaller the area of the water-absorbing layer 122 covered by the phase-change material 13, the stronger the water-absorbing performance of the water-absorbing layer 122, but the poorer the heat-storage performance of the phase-change material 13. In this embodiment, the area S2 covered by the phase-change material 13 on the water-absorbing layer 122 is set to be less than or equal to half of S1, within this range, both a water-absorbing performance requirement of the water-absorbing layer 122 may be met to ensure a wet-mopping effect of the mop cloth 12, and a heat-storage requirement of the phase-change material 13 may also be met to ensure the hot-mopping effect of the mop cloth 12.

When the phase-change material 13 is the solid-liquid phase-change material, in order to prevent leakage of the phase-change material 13 in a liquid state, in an example of the cleaning assembly 10 according to the present application, a sealed interlayer (not shown in the drawings) is provided between the fabric layer 121 and the water-absorbing layer 122, and the phase-change material 13 is filled within the sealed interlayer. The sealed interlayer may be adhered and fixed to the water-absorbing layer 122 or the fabric layer 121, or it may be sandwiched and fixed between the fabric layer 121 and the water-absorbing layer 122 by stitching the fabric layer 121 and the water-absorbing layer 122 together. A shape of the sealed interlayer is related to a distribution position of the phase-change material 13. When the phase-change material 13 is disposed at intervals between the fabric layer 121 and the water-absorbing layer 122, the sealed interlayer is a plurality of corresponding interlayer units spaced apart, where each interlayer unit is filled with the phase-change material 13. When the phase-change material 13 covers an entire lower surface of the water-absorbing layer 122, the shape of the sealed interlayer is substantially identical to the shape of the water-absorbing layer 122 to allow the phase-change material 13 to be filled into the sealed interlayer, so that the phase-change material 13 covers the entire lower surface of the water-absorbing layer 122.

In another embodiment, the sealed interlayer may also be disposed between the water-absorbing layer 122 and the bonding layer 123, and the phase-change material 13 is filled inside the sealed interlayer. At this time, the phase-change material 13 is disposed on the upper surface of the water-absorbing layer 122. In other embodiments, the sealed interlayer may also be disposed between the water-absorbing layer 122 and the fabric layer 121, and the sealed interlayer may also be disposed between the water-absorbing layer 122 and the bonding layer 123. This may achieve that the phase-change material 13 is simultaneously disposed on both the upper surface and the lower surface of the water-absorbing layer 122. It should be noted that when the phase-change material 13 is the solid-solid phase-change material, the phase-change material 13 may also be disposed within the sealed interlayer. By providing the sealed interlayer, it may not only reduce the probability of leakage during the phase-change process of the phase-change material 13, but also facilitate mounting and fixation of the phase-change material 13 onto the mop cloth 12, thereby lowering a complexity of mounting process for the phase-change material 13 on the mop cloth 12.

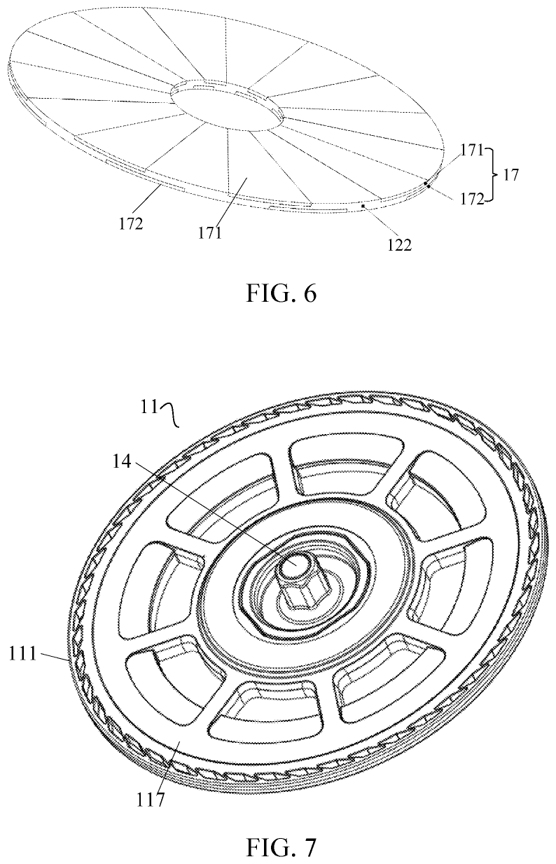

In an example of the cleaning assembly 10 of the present application, please refer to FIG. 6, the upper surface of the water-absorbing layer 122 is provided with a microcapsule layer 17. The microcapsule layer 17 includes a plurality of microcapsules, and the microcapsule is filled with the phase-change material 13. A size and number of microcapsules in the microcapsule layer 17 need to be determined according to various factors, such as a material property of the phase-change material 13 or a filling difficulty. The microcapsule layer 17 may be coated on the upper surface of the water-absorbing layer 122 by a coating technology, or may be adhered on the upper surface of the water-absorbing layer 122 via an adhesive. Preferably, in this embodiment, the microcapsule layer 17 is coated onto the upper surface of the water-absorbing layer 122. This manner may obtain a relatively uniform distribution of microcapsules. The microcapsule layer 17 may cover the entire upper surface of the water-absorbing layer 122, or may be a plurality of microcapsule layers 17 disposed at intervals on the upper surface of the water-absorbing layer 122, depending on the heat-storage requirement of the phase-change material 13 and the water-absorption performance of the water-absorbing layer 122.

In another embodiment, the microcapsule layer 17 may also be provided on the lower surface of the water-absorbing layer 122. In other embodiments, the microcapsule layer 17 may also be provided on the upper surface of the water-absorbing layer 122, and the microcapsule layer 17 is provided on the lower surface of the water-absorbing layer 122 at the same time. By disposing the microcapsule layer 17 on the water-absorbing layer 122, and filling the phase-change material 13 inside the microcapsule, in this way, it may not only reduce the probability of leakage of the phase-change material 13 during the phase-change process, but also prevent a microcapsule structure from easily escaping through a stitched pore of the mop cloth 12, thereby better retaining the phase-change material 13 within the mop cloth 12 and minimizing a loss of the phase-change material 13 during use. Meanwhile, under a same coating area, the microcapsule structure may also increase the contact area between the phase-change material 13 and the cleaning solution, thus facilitating an improvement of the thermal-storage efficiency of the phase-change material 13.

Please refer to FIGS. 5 and 6, in an example of the cleaning assembly 10 of the present application, the upper surface of the water-absorbing layer 122 is coated with a plurality of spaced-apart first microcapsule layers 171, and the lower surface of the water-absorbing layer 122 is coated with a plurality of spaced-apart second microcapsule layers 172. And the plurality of first microcapsule layers 171 and the plurality of second microcapsule layers 172 are disposed in a staggered manner in a vertical direction. It should be noted that, in this embodiment, the disposition in the staggered manner refers that projections of adjacent first microcapsule layers 171 and second microcapsule layers 172 along the thickness direction of the mop cloth 12 partially overlap and partially do not overlap, as shown in FIG. 6. There are various manners to dispose the plurality of first microcapsule layers 171 and the plurality of second microcapsule layers 172 in the staggered manner. In this embodiment, the plurality of first microcapsule layers 171 are distributed at intervals in a fan-shaped structure along a circumferential direction of the water-absorbing layer 122, and the plurality of second microcapsule layers 172 are also distributed at intervals in a fan-shaped structure along the circumferential direction of the water-absorbing layer 122. On the circumferential direction of the water-absorbing layer 122, the first microcapsule layers 171 and the second microcapsule layers 172 are disposed in the staggered manner in the vertical direction along the circumferential direction. In other embodiments, the plurality of first microcapsule layers 171 may also be distributed at intervals in multiple concentric rings along a radial direction of the water-absorbing layer 122, and the plurality of second microcapsule layers 172 may also be distributed at intervals in multiple concentric rings along the radial direction of the water-absorbing layer 122. On the radial direction of the water-absorbing layer 122, the first microcapsule layers 171 and the second microcapsule layers 172 are disposed in the staggered manner in the vertical direction along the radial direction.

By disposing the plurality of first microcapsule layers 171 and the plurality of second microcapsule layers 172 in the staggered manner in the vertical direction, on the one hand, the area covered by the microcapsule layer 17 on the water-absorbing layer 122 is maximized while guaranteeing the water-absorption performance requirement of the water-absorbing layer 122, thereby increasing a usage amount of the phase-change material 13 to ensure the heat-storage performance of the phase-change material 13 and the thermal conduction performance of the phase-change material 13 to the fabric layer 121; and on the other hand, since the first microcapsule layer 171 and the second microcapsule layer 172 are disposed in the staggered manner in the vertical direction, during the mopping process, when the mop cloth 12 is replenished with water, a water flow enters from the upper surface of the water-absorbing layer 122, bypasses the staggered positions of the first microcapsule layer 171 and the second microcapsule layer 172, and then flows from the lower surface of the water-absorbing layer 122 to the fabric layer 121. Thus, a path length of the water flow within the water-absorbing layer 122 may be increased, residence time of the water flow inside the mop cloth 12 may be prolonged and the contact time between the water flow and the phase-change material 13 may be increased, thereby increasing an outlet temperature of the water, and improving the hot-mopping effect of the mop cloth 12.

Please refer to FIG. 7 and FIG. 8, in an example of the cleaning assembly 10 of the present application, the phase-change material 13 is the solid-solid phase-change material, and the mop cloth mounting bracket 11 is at least partially composed of the phase-change material 13. The specific type of the solid-solid phase-change material is not limited, as long as the phase-change material 13 can meet a use strength and hardness requirement of the mop cloth mounting bracket 11 during the phase-change process. The mop cloth mounting bracket 11 may be entirely made of the phase-change material 13, or only the portion of the mop cloth mounting bracket 11 is in abutment with the mop cloth 12 may be made of the phase-change material 13, providing that the thermal conduction requirement between the phase-change material 13 and the mop cloth 12 are met. In this disposition, direct contact between the phase-change material 13 and the mop cloth 12 may be achieved, thereby reducing the thermal conduction path between the phase-change material 13 and the mop cloth 12, and further improving the heating effect of the phase-change material 13 on the mop cloth 12. Meanwhile, there is no need to additionally provide the phase-change material 13 on the mop cloth mounting bracket 11, thus, the weight of the mop cloth mounting bracket 11 itself may also be reduced, which facilitates to a lightweight design of the mop cloth mounting bracket 11.

Under the condition that the phase-change material 13 is the solid-solid phase-change material, in an example of the cleaning assembly 10 of the present application, the mop cloth mounting bracket 11 is integrally injection-molded from the phase-change material 13. That is, the entire mop cloth mounting bracket 11 is the phase-change material 13. In this disposition, a large area and a large weight of the phase-change material 13 may be obtained on the mop cloth mounting bracket 11, thereby during the cleaning process of the mop cloth 12, the contact area between the phase-change material 13 and the cleaning solution may be increased to improve the heat-storage efficiency and heat-storage energy of the phase-change material 13, so that during the cleaning operation with the mop cloth 12, thermal conduction time from the phase-change material 13 to the mop cloth 12 may be prolonged, and the hot-mopping effect of the mop cloth 12 may be further improved.

Under the condition that the phase-change material 13 is the solid-solid phase-change material, in an example of the cleaning assembly 10 of the present application, please refer to FIG. 8, the mop cloth mounting bracket 11 includes a main body 117. A material of the main body 117 may be a plastic material or a metallic material, depending specifically on whether the support requirement of the mop cloth mounting bracket 11 is met. A side of the main body 117 facing the mop cloth 12 includes the phase-change material 13, the phase-change material 13 is at least partially in abutment with the mop cloth 12. The phase-change material 13 may be integrally hot-melt bonded to the main body 117, or may be adhesively bonded, or may be fixed by bolts, or other connecting manners. The phase-change material 13 may be a disk-shaped structure that matches a shape of the mop cloth 12, or may be multiple local block structures spaced apart. To obtain a larger area for the phase-change material 13 and increase the contact area between the phase-change material 13 and the mop cloth 12, preferably, in this embodiment, the phase-change material 13 is a toroidal structure that matches the shape of the mop cloth 12. That is, the shape of the side of the phase-change material 13 facing the mop cloth 12 is substantially identical to the shape of the mop cloth 12. The phase-change material 13 and the mop cloth 12 may be bonded by an adhesive or may be adhered by a hook-and-loop fastener 16. In an embodiment, to convenient the assembly and disassembly between the mop cloth 12 and the mop cloth mounting bracket 11, in this embodiment, the hook-and-loop fastener 16 is provided on the side of the phase-change material 13 facing the mop cloth 12, and the side of the mop cloth 12 facing the phase-change material 13 is a hook fabric. Through adhering the hook fabric to the hook-and-loop fastener 16, a fixed connection between the mop cloth 12 and the mop cloth mounting bracket 11 is achieved.

By disposing the phase-change material 13 on the side of the main body facing the mop cloth 12, this disposition may achieve separate disposition of the main body 117 and the phase-change material 13, then, a supporting strength of the mop cloth mounting bracket 11 itself can be guaranteed by selecting an appropriate material for the main body 117, thereby reducing an impact of the phase-change material 13 on the supporting strength of the mop cloth mounting bracket 11, thus, it facilitates the selection of materials for the phase-change material 13. Meanwhile, since the main body 117 covers the surface of the side of the phase-change material 13 away from the mop cloth 12, selecting a material with a lower thermal conductivity for the main body may further improve a heat retention effect of the phase-change material 13, reducing heat loss of the phase-change material 13 to an external, and facilitating an improvement of the heating efficiency and the heating time provided by the phase-change material 13 to the mop cloth 12.

Under the condition that the phase-change material 13 is the solid-solid phase-change material, in an example of the cleaning assembly 10 of the present application, the mop cloth mounting bracket 11 includes the main body 117. The main body 117 is made of a metallic material, and the phase-change material 13 encases the main body 117. It should be noted that the metallic material in this embodiment refers to a metallic material possessing certain supporting strength and rigidity, such as aluminum, carbon steel, or stainless steel. The phase-change material 13 encasing the main body 117 may refer that an entire exposed surface of the metallic material is completely encased by the phase-change material 13, or part of areas of the metallic material is encased by the phase-change material 13, for example, the side of the metallic material facing the mop cloth 12 is encased by the phase-change material 13. By providing the main body 117 made of the metallic material and making the phase-change material 13 encase the metallic material, the main body 117 made of the metallic material may provide better support, thereby improving the supporting strength of the mop cloth mounting bracket 11. Meanwhile, since the phase-change material 13 encases the metallic material, the metallic material may provide better support to the phase-change material 13, thus reducing a selecting difficulty in an appropriate phase-change material 13. Furthermore, by encasing the phase-change material 13 around the outside of the main body 117, a usage amount of the phase-change material 13 may be increased, which facilitates an improvement of heat-storage performance of the phase-change material 13, so as to improve the heating effect of the phase-change material 13 on the mop cloth 12.

Please refer to FIG. 10 and FIG. 11, the present application further provides a cleaning system 30, including the cleaning device 20 in the above examples and a base station 31. The base station 31 includes a base station body 315 and a base 311, the base 311 is disposed at a lower end of the base station body 315. An accommodation cavity 3112 for accommodating the cleaning device 20 is disposed between the base 311 and the base station body 315. The base 311 is provided with a cleaning tank 312 for accommodating the cleaning solution, the cleaning tank 312 is located at a bottom of the accommodation cavity 3112, and the cleaning tank 312 can house the cleaning assembly 10 on the cleaning device 20. The cleaning solution is accommodated within the cleaning tank 312. A shape and number of the cleaning tanks 312 correspond to the shape and number of the mop cloths 12 on the cleaning assembly 10. Preferably, in this embodiment, there are two cleaning tanks 312, symmetrically mounted at the bottom of the accommodation cavity 3112. The cleaning device 20 is correspondingly provided with two cleaning assemblies 10. After the cleaning device 20 returns to the base station 31, the cleaning device 20 enters the accommodation cavity 3112, and the mop cloth 12 on the cleaning assembly 10 is immersed in the cleaning tank 312. The mop cloth 12 is cleaned through rotational movement between the mop cloth 12 and the cleaning tank 312. It should be noted that the base station 31 may further include conventional components in existing base stations 31, such as an energy system, a negative-pressure suction system, a wastewater tank, and a clean water tank, which is not repeated.

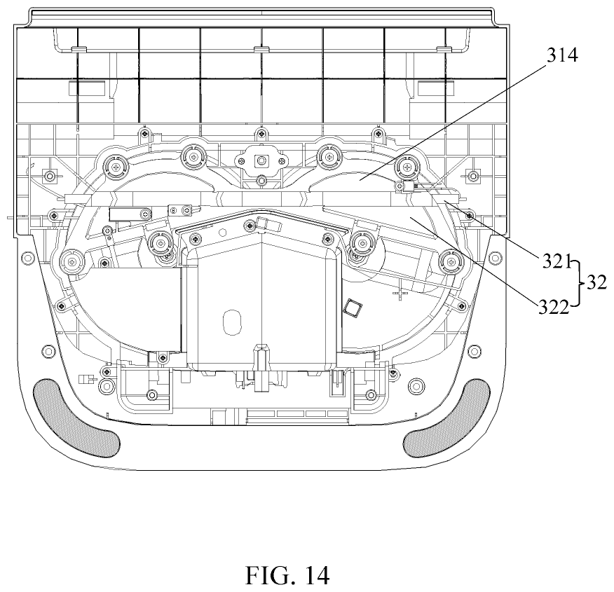

Please refer to FIG. 12 and FIG. 14. The cleaning tank 312 is provided with a heating apparatus 32 for heating the cleaning solution. In the prior art, an instant-heating component is disposed in a water circuit of the base station 31 for heating. During prolonged use, scale tends to accumulate inside this instant-heating component, making it difficult to maintain. The heating apparatus 32 in this solution directly heats the cleaning solution within the cleaning tank 312 of the base station 31. With this configuration, the scale does not readily generate inside the cleaning tank 312; and even if scale does generate, the cleaning tank 312 is easy to maintain, for example, by disassembling the cleaning tank 312 and cleaning it.

Specifically, the heating apparatus 32 may be disposed at any position within the cleaning tank 312, for example, on a bottom wall or side walls of the cleaning tank 312, as long as the cleaning solution can be heated. The specific structure of the heating apparatus 32 may be an electric heating wire heating module, an electric heating plate heating module, a phase-change material heating module, etc. The method by which the heating apparatus 32 heats the cleaning solution is not limited, for example, the cleaning solution located inside the cleaning tank 312 may be directly heated, or the cleaning solution that enters the cleaning tank 312 may be heated first, so that the heated cleaning solution is directly introduced into the cleaning tank 312. Since the heating apparatus 32 is disposed within the cleaning tank 312, a distance between the heating apparatus 32 and the cleaning tank 312 may be shortened, thus reducing heat loss during a transportation process of the cleaning solution. This facilitates an improvement of the heating efficiency of the cleaning solution and contributes to energy conservation and emission reduction.

When the cleaning device 20 completes a cleaning operation and returns to the base station 31, the cleaning assembly 10 is placed into the cleaning tank 312, and the mop cloth 12 contacts with the cleaning solution in the cleaning tank 312. If the mop cloth 12 needs to be cleaned by the hot water, the heating apparatus 32 is operated to heat the cleaning solution. The mop cloth 12 is cleaned in the heated cleaning solution. At this time, the phase-change material 13 on the cleaning assembly 10 absorbs the heat from the cleaning solution, and stores the heat. After the mop cloth 12 completes a cleaning action, the cleaning device 20 detaches from the base station 31 and proceeds to clean the floor. At this time, the phase-change material 13 releases the heat and transfers it to the mop cloth 12 to replenish the heat to the mop cloth 12, thereby extending the time of hot-water mopping of the mop cloth 12, and improving the cleaning effect of the mop cloth 12.

It should be noted that although the heating apparatus 32 provided in the cleaning tank 312 is aimed to enable the phase-change material 13 on the cleaning assembly 10 to absorb the heat during the cleaning operation, thereby providing the heat to the mop cloth 12 during the cleaning operation of the cleaning assembly 10, extending the time of hot-mopping of the mop cloth 12, and improving the cleaning effect of the mop cloth 12. However, in other embodiments, when the phase-change material 13 is not provided in the cleaning assembly 10, the heating apparatus 32 may still be provided in the cleaning tank 312. At this time, the heating apparatus 32 may be provided to heat the cleaning solution within the cleaning tank 312 to achieve the hot-water cleaning of the mop cloth 12, and improving the cleaning effect of the mop cloth 12.

Please refer to FIG. 10 and FIG. 12, in an example of the cleaning system 30 of the present application, the accommodation cavity 3112 is provided with a passage 3111 for the cleaning device 20 to enter and exit. The cleaning tank 312 includes a front tank portion 3121 disposed near the passage 3111 and a rear tank portion 3122 disposed away from the passage 3111. A height of a bottom wall of the front tank portion 3121 is lower than a height of a bottom wall of the rear tank portion 3122. That is, a depth of the front tank portion 3121 is greater than a depth of the rear tank portion 3122. As shown in FIG. 14, the heating apparatus 32 is disposed in the front tank portion 3121. The heating apparatus 32 may be a part of the bottom wall of the front tank portion 3121, or may be a separate heating member disposed on the side of the bottom wall of the front tank portion 3121 facing the ground. By thermally conductively connecting to the bottom wall of the front tank portion 3121, the bottom wall of the front tank portion 3121 is heated. In this embodiment, the side of the bottom wall of the front tank portion 3121 facing the ground is provided with a mounting cavity 314, and the heating apparatus 32 is disposed in the mounting cavity 314. Specifically, please refer to FIG. 12 and FIG. 14, the heating apparatus 32 includes a heating tube 321 and a thermal conductive member 322. The thermal conductive member 322 forms the bottom wall of the front tank portion 3121 and is thermally conductively connected to the heating tube 321, thereby achieving the heating of the heating apparatus 32 to the front tank portion 3121. Furthermore, a cover plate 313 is provided at an opening of the mounting cavity 314. The cover plate 313 covers the mounting cavity 314 to reduce the heat transfer from the heating apparatus 32 to the ground, and provide protection for the heating apparatus 32. By making the height of the bottom wall of the front tank portion 3121 lower than the height of the bottom wall of the rear tank portion 3122, and providing the heating apparatus 32 in the front tank portion 3121, the front tank portion 3121 may store a larger volume of cleaning solution, thereby achieving a better heating effect and higher heating efficiency of the cleaning solution by the heating apparatus 32.

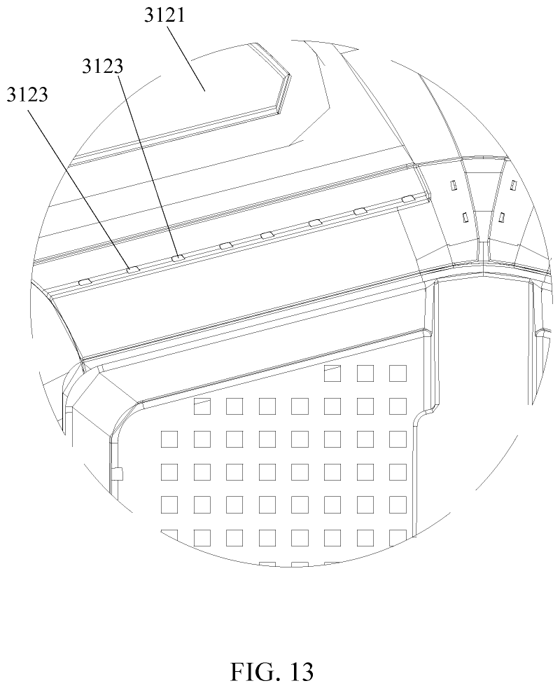

Please refer to FIG. 10, FIG. 12, and FIG. 13, in an example of the cleaning system 30 of the present application, the base station 31 includes a liquid supply pipeline (not shown in the drawings). The cleaning tank 312 is provided with water spray holes 3123, the water spray holes 3123 are connected to the liquid supply pipeline, the cleaning solution flows through the liquid supply pipeline and enters the interior of the cleaning tank 312 via the water spray holes 3123. The bottom wall of the cleaning tank 312 is provided with a protruding portion 3124, the protruding portion 3124 divides the cleaning tank 312 into the front tank portion 3121 and the rear tank portion 3122. The protruding portion 3124 extends along a radial direction of the cleaning tank 312. An end of the protruding portion 3124 is provided with a cleaning rib 3125, the cleaning rib 3125 is a strip-shaped protrusion structure extending along the radial direction of the cleaning tank 312 from a center of the cleaning tank 312 toward one side. Another end of the protruding portion 3124 is provided with the water spray holes 3123. A plurality of water spray holes 3123 are disposed along a length direction of the protruding portion 3124, and a water spray direction of these water spray holes 3123 is inclined toward the front tank portion 3121, so that water landing points of the water spray holes 3123 are located on the bottom wall of the front tank portion 3121. In this disposition, when the cleaning tank 312 is accidentally bumped or needs to be moved, the water spray holes 3123 may spray the water toward the front tank portion 3121 in time to cool and lower a temperature of the front tank portion 3121, and reduce a risk of burns to surrounding objects or personnel. It should be noted that when the cleaning assembly 10 is not in operation, the instant-heating component and the heating apparatus 32 in the base station 31 usually stop heating, so that when the cleaning tank 312 is accidentally bumped or moved, the water spray holes 3123 will spray cold water with a lower temperature, to cool and lower the temperature of the front tank portion 3121.

In an example of the cleaning system 30 of the present application, the base station 31 includes the liquid supply pipeline connected to the cleaning tank 312. The instant-heating component is disposed on the liquid supply pipeline to heat the cleaning solution, and the outlet of the instant-heating component is connected to the cleaning tank 312.

In this disposition, the cleaning solution in the cleaning tank 312 may be pre-heated by the instant-heating component, and then the cleaning solution is heated by the heating apparatus 32. Thus, the cleaning solution in the cleaning tank 312 may be heated twice, so as to improve the heating efficiency of the cleaning solution by the heating apparatus 32, and reduce a heating temperature of the cleaning solution by the instant-heating component at the same time, thereby reducing the probability of scale inside the instant-heating component due to excessively high temperature, and reducing a maintenance frequency of the instant-heating component. In the present application, the cleaning assembly is provided with the phase-change material, during the cleaning operation process of the cleaning assembly, the mop cloth can be heat through the phase-change material to achieve the hot-mopping of the mop cloth, thus, the cleaning effect of the cleaning assembly to the floor may be improved. Meanwhile, since the phase-change material has a high energy density, it may absorb or release large amounts of heat during the phase-change process, and can store a large amount of thermal energy under a relatively small volume or weight. Thus, mounting space occupied on the cleaning assembly may be saved, and overall weight of the cleaning assembly may be reduced. In addition, since the phase-change material only needs to absorb heat from the cleaning solution or the heating member for heating the cleaning solution when cleaning the mop cloth, and no additional heat source needs to be provided for the cleaning assembly, the structure is safer, simpler, and more energy-saving.

Therefore, the present application effectively overcomes some practical problems in the prior art, thus having high utilization value and practical significance. The above embodiments merely illustrate the principles and effects of the present application and are not intended to limit the present application. Any person skilled in the art may modify or change the above embodiments without departing from the spirit and scope of the present application. Consequently, all equivalent modifications or changes made by persons of ordinary skill in the art without departing from the spirit and technical concept disclosed in the present application shall be covered by the claims of the present application.

What is claimed is:

1. A cleaning assembly, comprising:
a mop cloth mounting bracket;
a mop cloth, wherein the mop cloth is mounted on the mop cloth mounting bracket;
wherein at least one of the mop cloth mounting bracket or the mop cloth comprises a phase-change material, the phase-change material is thermally conductively connected to the mop cloth, such that when the mop cloth is in a non-cleaning operation, the phase-change material absorbs heat from a heat source, and when the mop cloth performs a cleaning operation, the phase-change material releases the heat into the mop cloth; wherein the non-cleaning operation comprises at least part of a cleaning process, a drying process, or a soaking-and-heating process of the mop cloth.

2. The cleaning assembly according to claim 1, wherein the heat source comprises at least one of a heating apparatus or hot water.

3. The cleaning assembly according to claim 1, wherein a side of the mop cloth mounting bracket away from the mop cloth is provided with a connecting portion that can be detachably connected to a drive assembly, the connecting portion comprises a magnetic attraction structure that can be attracted to a drive shaft of the drive assembly, or, the connecting portion comprises a snap-fit structure that can be snap-fitted with the drive assembly.

4. The cleaning assembly according to claim 1, wherein an outer periphery of the mop cloth mounting bracket is provided with a buffer portion for absorbing an edge collision force of the cleaning assembly, the buffer portion comprises a soft rubber structure, and the soft rubber structure is provided with a plurality of deformable hollowed-out regions.

5. The cleaning assembly according to claim 1, wherein the mop cloth mounting bracket is provided with a sealing cavity, and the sealing cavity is filled with the phase-change material.

6. The cleaning assembly according to claim 5, wherein the mop cloth mounting bracket is further provided with an opening communicating with the sealing cavity, a liquid phase-change material is injected into the sealing cavity through the opening, and the opening is closed with a sealing cover.

7. The cleaning assembly according to claim 5, wherein the mop cloth mounting bracket comprises an upper cover body and a lower cover body, the upper cover body and the lower cover body are sealingly connected to form the sealed cavity; and the mop cloth mounting bracket further comprises hot-melt adhesive, and the upper cover body and the lower cover body are hot-melt bonded via the hot-melt adhesive.

8. The cleaning assembly according to claim 7, wherein
the lower cover body is thermally connected to the mop cloth, and a thermal conductivity of the lower cover body is greater than a thermal conductivity of the upper cover body; and/or
an adhesive layer is provided on a side of the upper cover body away from the lower cover body; and/or
the lower cover body comprises a thermal conductive rib, and at least part of the thermal conductive rib extends into interior of the sealing cavity.

9. The cleaning assembly according to claim 1, wherein the mop cloth comprises a fabric layer, a water-absorbing layer, and a bonding layer connected from bottom to top in sequence; a side of the mop cloth mounting bracket facing the mop cloth is provided with an adhesive portion, and the bonding layer is adhesively connected to the adhesive portion; and the phase-change material is disposed in at least one of: between the fabric layer and the water-absorbing layer or between the water-absorbing layer and the bonding layer.

10. The cleaning assembly according to claim 9, wherein a sum of areas of an upper surface and a lower surface of the water-absorbing layer is S1, and an area S2 covered by the phase-change material on the water-absorbing layer is less than or equal to half of S1.

11. The cleaning assembly according to claim 9, wherein a sealed interlayer is provided at least one of: between the fabric layer and the water-absorbing layer or between the water-absorbing layer and the bonding layer; and the phase-change material is filled within the sealed interlayer.

12. The cleaning assembly according to claim 9, wherein at least one of an upper surface or a lower surface of the water-absorbing layer is coated with a microcapsule layer, wherein the microcapsule layer comprises a plurality of microcapsules, and the microcapsule is filled with the phase-change material.

13. The cleaning assembly according to claim 12, wherein the upper surface of the water-absorbing layer is coated with a plurality of spaced-apart first microcapsule layers, the lower surface of the water-absorbing layer is coated with a plurality of spaced-apart second microcapsule layers, and the plurality of first microcapsule layers and the plurality of second microcapsule layers are disposed in a staggered manner in a vertical direction.

14. The cleaning assembly according to claim 1, wherein the phase-change material is a solid-solid phase-change material, the mop cloth mounting bracket is at least partially composed of the phase-change material, or, the mop cloth mounting bracket is integrally injection-molded from the phase-change material.

15. The cleaning assembly according to claim 14, wherein the mop cloth mounting bracket comprises a main body, a side of the main body facing the mop cloth comprises the phase-change material, and the phase-change material is at least partially in abutment with the mop cloth; and/or
wherein the mop cloth mounting bracket comprises a main body, the main body is made of a metallic material, and the phase-change material encases the main body.

16. A cleaning device, comprising a cleaning assembly, wherein the cleaning assembly comprises:
a mop cloth mounting bracket;
a mop cloth, wherein the mop cloth is mounted on the mop cloth mounting bracket;
wherein at least one of the mop cloth mounting bracket or the mop cloth comprises a phase-change material, the phase-change material is thermally conductively connected to the mop cloth, such that when the mop cloth is in a non-cleaning operation, the phase-change material absorbs heat from a heat source, and when the mop cloth performs a cleaning operation, the phase-change material releases the heat into the mop cloth; wherein the non-cleaning operation comprises at least part of a cleaning process, a drying process, or a soaking-and-heating process of the mop cloth.

17. The cleaning device according to claim 16, wherein the cleaning device comprises a body, the cleaning device comprises two cleaning assemblies, at least one of the cleaning assemblies is swingably connected to the body to have a retracted position and a swing-out position relative to the body, when the cleaning assembly is in the swing-out position, the cleaning assembly is farther away from the body than being in the retracted position, and the cleaning device can perform edge cleaning; and when the mop cloth of the cleaning assembly absorbs heat from the heat source, the cleaning assembly is in the retracted position.

18. A cleaning system, comprising:
a cleaning device, wherein cleaning device comprises a cleaning assembly, and the cleaning assembly comprises:
a mop cloth mounting bracket;
a mop cloth, wherein the mop cloth is mounted on the mop cloth mounting bracket;
wherein at least one of the mop cloth mounting bracket or the mop cloth comprises a phase-change material, the phase-change material is thermally conductively connected to the mop cloth, such that when the mop cloth is in a non-cleaning operation, the phase-change material absorbs heat from a heat source, and when the mop cloth performs a cleaning operation, the phase-change material releases the heat into the mop cloth; wherein the non-cleaning operation comprises at least part of a cleaning process, a drying process, or a soaking-and-heating process of the mop cloth;
a base station, wherein the base station comprises a base, and the base is provided with a cleaning tank for accommodating a cleaning solution; wherein the cleaning tank is provided with a heating apparatus for heating the cleaning solution.

19. The cleaning system according to claim 18, wherein the base is provided with a passage for the cleaning device to enter and exit, the cleaning tank comprises a front tank portion disposed near the passage and a rear tank portion disposed away from the passage, a height of a bottom wall of the front tank portion is lower than a height of a bottom wall of the rear tank portion, and the heating apparatus is disposed in the front tank portion;
wherein the base station comprises a liquid supply pipeline, the cleaning tank is provided with water spray holes, the water spray holes are connected to the liquid supply pipeline; and a spray direction of the water spray holes is inclined toward the front tank portion, so that a water landing point of the water spray holes is located in the front tank portion.

20. The cleaning system according to claim 18, wherein the base station comprises a liquid supply pipeline connected to the cleaning tank, the liquid supply pipeline is provided with an instant heating assembly for heating the cleaning liquid, and an outlet of the instant heating assembly is connected to the cleaning tank.
